(19) United States
(12) Patent Application Publication
(10) Pub. No.: US 2021/0366084 A1
(43) Pub. Date: Nov. 25, 2021

(54) DEBLURRING PROCESS FOR DIGITAL IMAGE PROCESSING

(71) Applicant: QUALCOMM Incorporated, San Diego, CA (US)

(72) Inventors: Yang-Yao Lin, Brooklyn, NY (US); Shang-Chih Chuang, San Diego, CA (US); Chung-Chi Tsai, San Diego, CA (US); Xiaoyun Jiang, San Diego, CA (US)

(21) Appl. No.: 16/882,082

(22) Filed: May 22, 2020

(51) Int. Cl. G06T 5/00; G06T 5/20; G06T 5/50; G06T 7/00

(52) U.S. Cl. CPC G06T 5/003; G06T 5/20; G06T 5/50; G06T 7/97; G06T 2207/10024; G06T 2207/20224; G06T 2207/20032; G06T 2207/20028; G06T 2207/20076; G06T 2207/20216

(57) ABSTRACT

Aspects of the present disclosure relate to QCFA deblurring. An example method includes obtaining an image to be processed and determining an average of pixel values between a first one or more pixels and a second one or more pixels of the image. The second one or more pixels neighbor the first one or more pixels. The method also includes determining a difference between pixel values of the first one or more pixels and the second one or more pixels, generating one or more weights based on the average and the difference, and combining the average and the difference based on the one or more weights to generate a deblurred pixel value. A processed image includes one or more deblurred pixel values.

### TECHNICAL FIELD

This disclosure relates generally to digital image processing, such as a deblurring process for digital images.

### BACKGROUND

Digital cameras may include a lens, an aperture, and an image sensor with a plurality of sensor pixels. Light flows through the lens and the aperture until reaching the image sensor. Each sensor pixel may include a photodiode which captures image data based on sensing the incoming light. One or more processors may generate an image based on the captured image data. The image sensor is coupled to a color filter array so that the image data includes color information. In this manner, one or more processors may generate a color image based on the captured image data.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

In some aspects, an example method for digital image processing is described. The example method includes obtaining an image to be processed, and determining an average of pixel values between a first one or more pixels and a second one or more pixels of the image. The second one or more pixels neighbor the first one or more pixels in the image. The method also includes determining a difference between pixel values of the first one or more pixels and the second one or more pixels, generating one or more weights based on the average and the difference, and combining the average and the difference based on the one or more weights to generate a deblurred pixel value. A processed image includes one or more deblurred pixel values.

In some aspects, an example device for digital image processing is described. The example device includes a memory and one or more processors. The one or more processors are configured to obtain an image to be processed, and determine an average of pixel values between a first one or more pixels and a second one or more pixels of the image. The second one or more pixels neighbor the first one or more pixels in the image. The one or more processors are also configured to determine a difference between pixel values of the first one or more pixels and the second one or more pixels, generate one or more weights based on the average and the difference, and combine the average and the difference based on the one or more weights to generate a deblurred pixel value. A processed image includes one or more deblurred pixel values.

In some aspects, an example non-transitory, computer readable medium is described. The computer readable medium includes instructions that, when executed by one or more processors of a device, cause the device to obtain an image to be processed, and determine an average of pixel values between a first one or more pixels and a second one or more pixels of the image. The second one or more pixels neighbor the first one or more pixels in the image. Execution of the instructions also causes the device to determine a difference between pixel values of the first one or more pixels and the second one or more pixels, generate one or more weights based on the average and the difference, and combine the average and the difference based on the one or more weights to generate a deblurred pixel value. A processed image includes one or more deblurred pixel values.

In some aspects, another device for digital image processing is described. The device includes means for obtaining an image to be processed, and means for determining an average of pixel values between a first one or more pixels and a second one or more pixels of the image. The second one or more pixels neighbor the first one or more pixels in the image. The device also includes means for determining a difference between pixel values of the first one or more pixels and the second one or more pixels, means for generating one or more weights based on the average and the difference, and means for combining the average and the difference based on the one or more weights to generate a deblurred pixel value. A processed image includes one or more deblurred pixel values.

In some implementations, each pixel of the first one or more pixels is associated with an exposure window of a first size, and each pixel of the second one or more pixels is associated with an exposure window of a second size smaller than the first size. In some implementations, the device may include means for determining a first average pixel value between a first pixel and a second pixel of the first one or more pixels, means for determining a second average pixel value between a third pixel and a fourth pixel of the second one or more pixels, and means for generating an adjusted second average pixel value by applying a gain to the second average pixel value. The gain is based on the second size compared to the first size. The average includes averaging the first average pixel value and the adjusted second average pixel value, and the difference includes subtracting the second average pixel value from the first average pixel value. In some implementations, the device may include means for determining whether one or more pixel values of the first one or more pixels are saturated. Generating the deblurred pixel value is based on the pixel values of the first one or more pixels not being saturated.

The image to be processed may include a plurality of patches of pixel values, and a patch of the plurality of patches includes the first one or more pixels and the second one or more pixels. The device may also include means for determining an average for each patch of the plurality of patches to generate a total average, and means for determining a difference for each patch of the plurality of patches to generate a total difference. The device may further include one or more of means for applying a median filter to the total difference before generating the deblurred pixel value, means for applying a first bilateral filter to the total average before generating the one or more weights, or means for applying a second bilateral filter to the total difference before generating the one or more weights. In some implementations, generating the one or more weights includes generating a weight map including a plurality of weights. For each weight of the plurality of weights, the weight is associated with a patch of the plurality of patches, and generating the weight includes adjusting a first difference of the total difference to an adjusted difference based on a first average of the total average corresponding to the first difference, adjusting neighboring differences to the first difference of the total difference based on the adjustment to the first difference, and determining a sum of absolute differences as the weight. The sum of absolute differences may include a sum of an absolute difference between the first average and the adjusted first difference and absolute differences between each neighboring average and the corresponding adjusted neighboring difference.

In some implementations, generating the one or more weights also includes generating a weighting curve. Generating the weighting curve may include determining a lower threshold based on the distribution of weights in the weight map, determining an upper threshold based on the distribution of weights, and determining an alpha. For each corresponding average and difference of the total average and the total difference, combining the average and the difference based on the one or more weights may include, based on a corresponding weight in the weight map being less than the lower threshold, setting the deblurred pixel value as the difference, based on the corresponding weight being greater than the upper threshold, setting the deblurred pixel value as the average, and based on the corresponding weight being greater than the lower threshold and less than the upper threshold, generating the deblurred pixel value as the deblurred pixel value=average*alpha−difference*(1−alpha). alpha=(the corresponding weight−the lower threshold)/(the upper threshold−the lower threshold). In some implementations, the lower threshold is one standard deviation below a mean weight of the distribution of weights, and the upper threshold is one standard deviation above the mean weight of the distribution of weights. In some implementations, the image to be processed is generated from an image sensor coupled to a quad color filter array, and the first one or more pixels and the second one or more pixels are associated with color filters of a same color from the quad color filter array.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is an example depiction of a tile of a Bayer color filter array.

FIG. 2 is a depiction of an example Bayer quad color filter array tile and its conceptual equivalent of a Bayer color filter array tile after binning.

FIG. 3 is a block diagram of an example device to perform digital image processing.

FIG. 4 is a block diagram of an example image processing pipeline.

FIG. 5 is a block diagram of an example quad color filter array deblurring process.

FIG. 6 is an illustrative flow chart depicting an example operation of performing quad color filter array deblurring.

FIG. 7 is an example portion of an example Bayer quad color filter array image conceptualized as an array of pixel values.

FIG. 8 is a block diagram of an example value extractor for quad color filter array deblurring.

FIG. 9 is a block diagram of an example weight calculator for quad color filter array deblurring.

FIG. 10 is a depiction of example portions of a total average including an array of averages and a corresponding total difference including an array of differences.

FIG. 11 is a depiction of an example weighting curve correlating weights to deblurred pixel values for generating a processed image.

### DETAILED DESCRIPTION

Aspects of the present disclosure are regarding a deblurring process during digital image processing. An image sensor used to capture color information in the image data is coupled to a color filter array (CFA). A CFA is a mosaic of color filters, and each color filter may filter light for an associated sensor pixel of the image sensor. In this manner, light directed towards a sensor pixel of the image sensor passes through a color filter of the CFA before reaching the sensor pixel, and the sensor pixel captures color information for the specific color associated with the color filter (such as blue color information, red color information, or green color information). CFAs that are a mosaic of red, blue, and green color filters may be referred to as an RGB CFA. An example RGB CFA is a Bayer CFA.

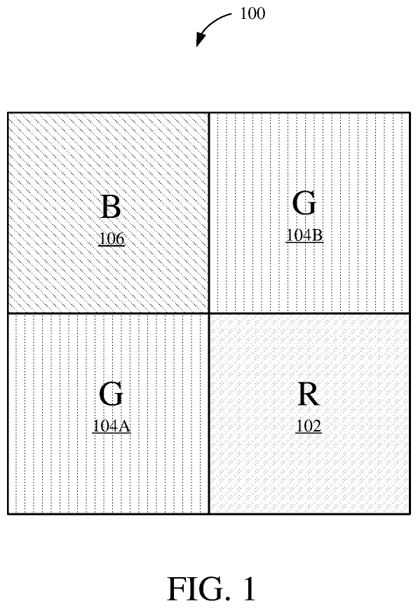

The mosaic of color filters for a Bayer CFA includes a plurality of tiles of size 2 color filters by 2 color filters (2×2). Each tile includes a similar pattern of one blue color filter, two green color filters, and one red color filter. FIG. 1 is an example depiction of a Bayer CFA tile 100. The Bayer CFA tile 100 illustrates the pattern of the color filters in each tile of the Bayer CFA. As depicted, the Bayer CFA tile 100 includes a red color filter (R filter) 102 and a blue color filter (B filter) 106 separated by a green color filter (G filter) 104A and a G filter 104B. The image data captured by the image sensor coupled to a Bayer CFA includes red, blue, and green color information throughout, and a processed image generated by processing the image data may include color information of various colors based on the red, blue, and green color information in the image data.

Each sensor pixel includes one or more photodiodes to measure the light received at the sensor pixel when the photodiode is exposed. Capturing image data by the image sensor for an image frame includes exposing the one or more photodiodes of each sensor pixel for an amount of time (referred to as an exposure window). The exposure window may be adjusted based on a camera configuration. For example, a camera may be configured to generate images of an action scene (such as a sporting event, people running, or other scenarios where objects are moving in the scene). To reduce motion blur in an image frame, an exposure window may be decreased for the image frame so that less movement in the scene may occur while the photodiodes are exposed for measuring received light. In another example, a camera may be configured to generate images in a low light setting (such as during night, when the camera is indoors, or other scenarios where ambient light in the scene may be limited). To ensure sufficient light information is captured to generate details in an image from the camera, an exposure window may be increased for an image frame so that more light is received at the photodiodes during the exposure window. One problem with increasing the exposure window includes increasing blur in an image from the camera. For example, increasing the exposure window increases the amount of time that one or more objects (or the camera) may move while the photodiodes of the image sensor are exposed for the image frame. However, decreasing the exposure window may decrease the light measured by each photodiode. As a result, noise that exists in the image data may increase with reference to the measured light (which may be referred to as the measured signal). In other words, a signal to noise ratio (SNR) may decrease as the exposure window decreases.

The measured light for a sensor pixel may be output as a pixel value. The pixel value may be an analog voltage or current, or the pixel value may be a digital representation of a voltage or current (such as after an analog to digital conversion by an analog front end for an image sensor). One or more pixel values may be referred to as image data. An array of pixel values from the image sensor for one exposure window may be referred to as an image frame or an image. Image data captured by an image sensor (i.e., an image to be processed by an image processing pipeline) is processed by the image processing pipeline to generate a final image. The image processing pipeline may include an image signal processor (ISP) to apply one or more filters to the image data. Example filters include a denoising filter, an edge enhancement filter, a color balance filter, and a deblurring filter. A deblurring filter may be configured to reduce blur caused by motion during the exposure window. For example, the deblurring filter may be a spatial based deblurring filter. A spatial based deblurring filter may include a kernel applied at each pixel value to determine a reduced blur value based on neighboring pixel values and the current pixel value. The deblurring filter may alternatively or also include a temporal based deblurring filter. A temporal based deblurring filter may be used to determine a reduced blur pixel value based on the pixel values at the same location across a sequence of image frames from the image sensor. For example, the pixel values over time may be combined (such as by determining a weighted average, a simple average, a median, and so on). The success in reducing blur by the deblurring filter may decrease as the exposure window size increases (and blur distortions increase).

Instead of increasing an exposure window to have more light information for a pixel of an image (thus increasing the SNR), one or more processors may perform binning during processing of the image data. Binning refers to combining multiple pixel values into one pixel value. For example, pixel values from two or more sensor pixels are summed to generate a new pixel value. As a result of binning an image from the image sensor, a generated image has a lower resolution (a lower number of pixel values) than the image on which binning was performed.

Binning may be performed on image data from neighboring sensor pixels coupled to a similar color filter. For example, image data from neighboring sensor pixels coupled to G filters may be binned to generate one pixel value, image data from neighboring sensor pixels coupled to R filters may be binned to generate one pixel value, image data from neighboring sensors pixels couple to B filters may be binned to generate one pixel value, and so on. The mosaic of the CFA may be configured to place similar color filters together for neighboring sensor pixels. In this manner, a tile of the CFA may include multiple color filters of the same color neighboring one another. An example CFA with neighboring color filters of the same color in each tile is a quad CFA (QCFA). A QCFA includes tiles of size 4 color filters by 4 color filters (4×4). An example QCFA is a Bayer QCFA. A Bayer QCFA includes a 2×2 patch of R filters and a 2×2 patch of B filters separated by a first 2×2 patch and a second 2×2 patch of G filters. Each color filter of the Bayer QCFA tile is coupled to a sensor pixel of the image sensor. In this manner, each 2×2 patch of similar color filters from the Bayer QCFA is coupled to a group of four sensor pixels from the image sensor. Binning may include combining the image data from the group of four sensor pixels coupled to a 2×2 patch of similar color filters. For example, for a Bayer QCFA tile, the pixels values from the four sensor pixels coupled to the 2×2 patch of R filters may be combined to generate one pixel value associated with the red color. The pixel values from the four sensor pixels coupled to the 2×2 patch of B filters may be combined to generate one pixel value associated with the blue color. The pixel values from the four sensor pixels coupled to the first 2×2 patch of G filters may be combined to generate a first pixel value associated with the green color. The pixel values from the four sensor pixels coupled to the second 2×2 patch of G filters may be combined to generate a second pixel value associated with the green color. In this manner, 16 pixel values may be converted to 4 pixel values through binning.

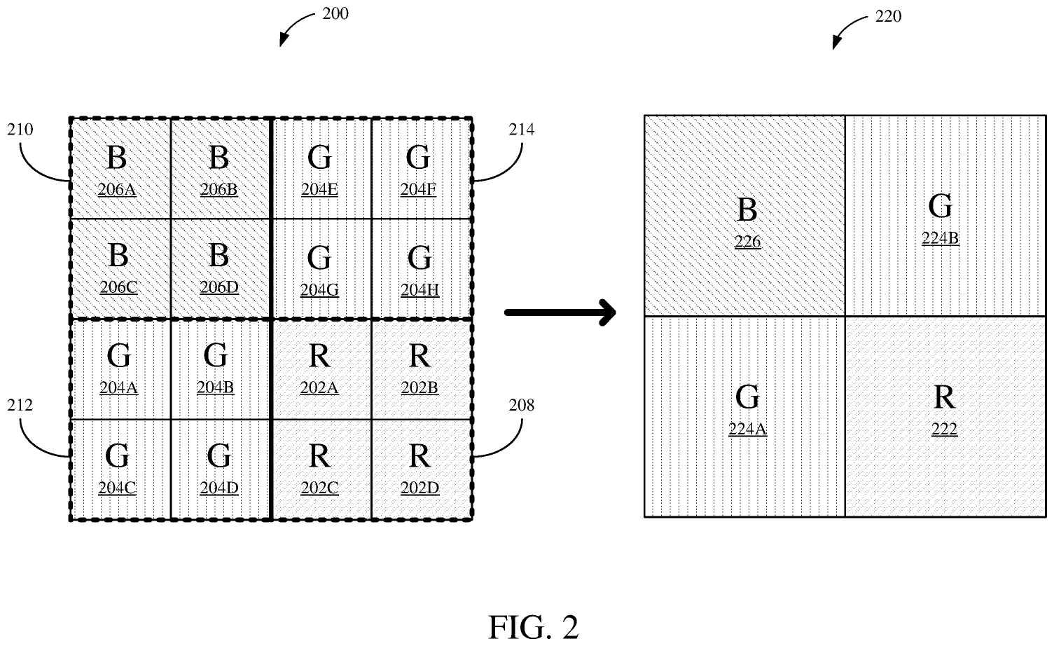

FIG. 2 is a depiction of an example Bayer QCFA tile 200 and its conceptual equivalent of a Bayer CFA 220 tile after binning pixel values from sensor pixels coupled to the Bayer QCFA tile 200. The Bayer QCFA tile 200 includes a 2×2 patch 208 of R filters 202A-202D, a 2×2 patch 210 of B filters 206A-206D, a first 2×2 patch 212 of G filters 204A-204D, and a second 2×2 patch 214 of G filters 204E-204H. If there exists sufficient ambient light in a scene (such as the SNR being greater than a threshold across the image data from the sensor pixels), binning of the pixel values might not be performed. In this manner, the resolution of an image from the image sensor may be the same as the resolution of the final image generated by the image processing pipeline after processing the image from the image sensor. If binning is to be performed, the image data from the sensor pixels associated with each 2×2 patch of color filters is combined to generate a pixel value. The generated pixel value via binning may be equivalent to using a larger sensor pixel that is the same size as four sensor pixels combined from the image sensor. For example, binning pixel values associated with the Bayer QCFA tile 200 may be conceptually equivalent to using a different image sensor with a 2×2 tile of larger sensor pixels coupled to a Bayer CFA tile 220 (which would include one sensor pixel coupled to an R filter 222, one sensor pixel coupled to a B filter 226, and two sensor pixels coupled to G filters 224A and 224B). In this manner, image data from 16 sensor pixels coupled to the Bayer QCFA tile 200 is binned to generate four pixel values. Binning pixel values associated with one pattern of color filters (such as a Bayer QCFA) to generate pixel values associated with another pattern of color filters (such as a Bayer CFA) may be referred to as remosaicing. A device may be configured to perform remosaicing when processing an image from an image sensor (such as in low light scenarios).

A camera may also be configured to perform high dynamic ranging (HDR), and a device may generate HDR images based on image data captured by an image sensor of the camera. In performing HDR, multiple sets of image data (multiple images) are generated by the image sensor using different size exposure windows. In some implementations of HDR, an image sensor generates three images. For example, a first image is generated using a first size exposure window for all of the sensor pixels of the image sensor, a second image is generated using a second size exposure window for all of the sensor pixels of the image sensor, and a third image is generated using a third size exposure window for all of the sensor pixels of the image sensor. For the three pixel values at the same location in the three images, the three pixel values may be combined (such as averaged, summed, or other suitable combination) to generate an HDR value. An HDR image may include the HDR values determined for each set of corresponding pixel values. One problem with performing HDR with the exposure window being the same size across all sensor pixels of the image sensor is that image data must be captured over multiple images. Capturing multiple images may increase the amount of time during which the camera or objects in the scene may move (which may increase blur in a resulting HDR image).

To reduce the amount of time for capturing image data in performing HDR, an image sensor may be configured such that different sets of sensor pixels are associated with different size exposure windows. For example, a first set of sensor pixels may be associated with a first size exposure window, a second set of sensor pixels may be associated with a second size exposure window greater than the first size exposure window, and a third set of sensor pixels may be associated with a third size exposure window greater than the second size exposure window. In this manner, different sets of image data associated with different size exposure windows may be captured by the image sensor in generating a single image. The three sets of image data may then be combined to generate an HDR image. In this manner, performing HDR may require capturing only a single image by the image sensor.

Performing HDR for an image sensor coupled to a Bayer QCFA may include setting multiple exposure window sizes for different sensor pixels associated with a 2×2 patch of color filters (such as each patch 208-214). For example, for patch 210, a first size exposure window may be configured for a sensor pixel associated with the B filter 206A, a second size exposure window (greater than the first size) may be configured for the two sensor pixels associated with the B filters 206B and 206C, and a third size exposure window (greater than the second size) may be configured for a sensor pixel associated with the B filter 206D. The image sensor may then capture image data based on the different exposure window sizes. In this manner, image data from the sensor pixel associated with the B filter 206A is part of the first set of image data (associated with the first size exposure window), image data from the sensor pixels associated with the B filter 206B and 206C is part of the second set of image data (associated with the second size exposure window), and image data from the sensor pixel associated with the B filter 206D is part of the third set of image data (associated with the third size exposure window). In performing HDR, an HDR value associated with the patch 210 may be a function of the pixel values generated by the sensor pixels associated with B filters 206A-206D (such as a weighted summation, simple summation, averaging, and so on). Similar configurations of different exposure window sizes may also be used for the sensor pixels associated with each of patches 208, 212, and 214. The pixel values associated with each patch 208, 212, 214, and the other patches may then be combined. In this manner, the Bayer QCFA image data for one image from the image sensor may be remosaiced to Bayer CFA image data for an HDR image.

While blur may be reduced by not requiring capturing image data for multiple images to generate an HDR image, a blur may still exist in a generated HDR image as a result of motion during an exposure window for generating a single image by the image sensor. A blur may also exist as a result of a point spread associated with the image sensor. As referred to herein, a point spread may be a diffraction of light from an infinitely small point source of light. An image sensor captures light from multiple light points, for which the light has diffracted at a pattern associated with the distance of the light from the image sensor. In addition to the distance of the light source from the image sensor, the pattern is also affected by different components of a camera, such as one or more lenses to focus the light onto the image sensor. The pattern of diffraction of the point spread may be mapped by a point spread function, and an image sensor may be associated with the point spread function. Assuming no blur is associated with motion (the image sensor and the scene remain stationary), any blur is associated with the point spread, as indicated in equation (1) below:

Captured pixel values=PSF*Unblurred pixel values (1)

Captured pixel values are the pixel values as captured by the sensor pixels. The unblurred pixel values are what the pixel values from the image sensor should be if no blur exists. The PSF is the point spread function that would be applied to the unblurred pixel values to generate the captured pixel values. As shown, the captured pixel values are a convolution of the unblurred pixel values and the point spread function. A typical ISP deblurring filter may be applied to attempt to reduce blur associated with motion and to reduce blur associated with a point spread. To reduce blur associated with a point spread, an ISP deblurring filter may attempt to apply deconvolution (based on equation (1)) to generate the unblurred pixel values.

However, the point spread function associated with an image sensor is typically unknown. Therefore, many typical ISP deblurring filters may include a prediction of the unknown point spread function for the image sensor. Deconvolution is performed using the predicted point spread function to estimate the unblurred pixel values from the captured pixel values. For example, a point spread may be assumed to be a uniform diffraction (which may be referred to as spread) in all directions, and the amount of spread may be based on a distance the light travels from the source to the image sensor. However, spread is typically not uniform in all directions (and may also depend on other factors, such as a location on a lens the light passes through one or more lenses towards the image sensor). In addition, blur associated with motion may cause errors in predicting the point spread function (such as if the image processing pipeline is configured to assume no blur associated with motion exists when estimating the point spread function). Therefore, the predicted point spread function and deconvolution based on the predicted point spread function are inaccurate. As a result, applying a typical ISP deblurring filter may produce pixel values with errors associated with attempting to remove blur associated with point spread and thus not produce a desired result in reducing blur for a final image.

In some implementations, an image processing pipeline (such as an ISP) may perform a multi-exposure deblurring process to filter or reduce blur based on image data captured using different exposure windows. The multi-exposure deblurring process may be performed by an image processing pipeline to reduce blur associated with motion and/or to reduce blur associated with a point spread. The multi-exposure deblurring process may be separate and independent from a typical deblurring filter noted above. Instead of attempting to predict a point spread function, applying the multi-exposure deblurring process reduces blur based on image data captured using shorter exposure windows compared to image data captured using longer exposure windows during an image frame (since a shorter exposure window causes less blur caused by motion). In this manner, differences in blur based on motion and blur based on a point spread can be determined based on corresponding image data captured using different exposure windows. As a result, an image processing pipeline can better reduce blur caused by motion and/or caused by point spread by applying the multi-exposure deblurring process. These and other aspects and advantages of the example implementations are discussed in more detail below.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, techniques, algorithms, logic blocks, processing, and other symbolic representations of operations on data bits within a computer memory. In the present disclosure, a procedure, technique, algorithm, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any suitable image processing device (such as cameras, smartphones, tablets, laptop computers, or other devices) configured to process image data captured using one or more image sensors. While described below with respect to a device having or coupled to one camera and one image sensor, aspects of the present disclosure are applicable to devices having any number of cameras and image sensors (including no cameras, in which image data is provided to the device). Therefore, a device is not limited to having one camera.

The term “device” is not limited to one or a specific number of physical objects (such as one smartphone, one controller, one processing system, one system of chip (SoC), and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific implementations. For example, a system may be implemented on one or more printed circuit boards or other substrates and may have movable or static components. While the below description and examples use the term “system” to describe various aspects of this disclosure, the term “system” is not limited to a specific configuration, type, or number of objects.

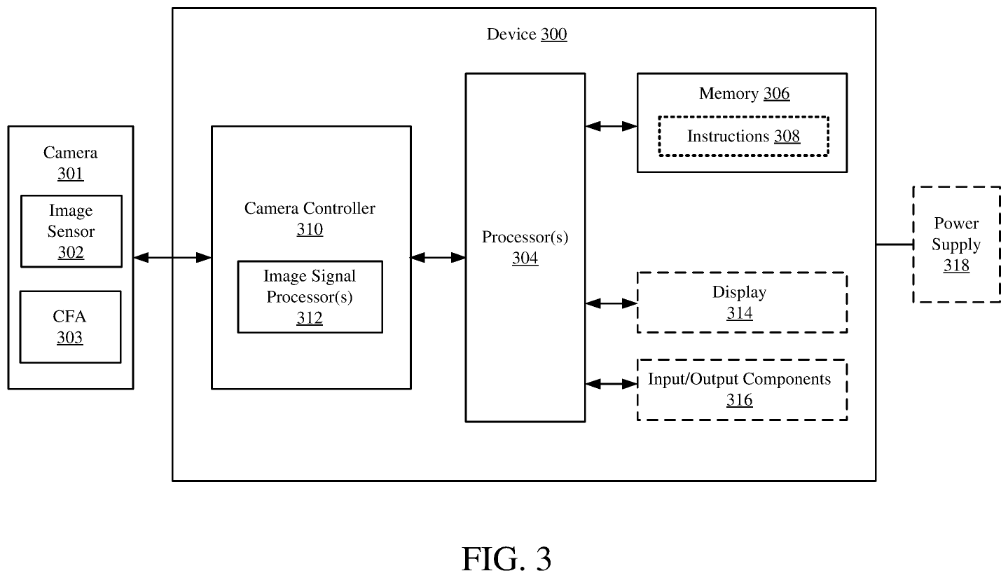

FIG. 3 is a block diagram of an example device 300 to perform digital image processing. The device 300 may include or be coupled to a camera 301. The example device 300 also includes one or more processors 304, a memory 306 storing instructions 308, and a camera controller 310. The device 300 may also include (or be coupled to) a display 314 and a number of input/output (I/O) components 316, and a power supply 318. The device 300 may include additional features or components not shown. For example, a wireless interface, which may include a number of transceivers and a baseband processor, may be included for a wireless communication device (e.g., a smartphone or a tablet). The example device 300 is for illustrative purposes in describing aspects of the disclosure, and the disclosure is not limited to any specific examples or illustrations herein, including the example device 300.

A camera 301 may be capable of capturing image data for individual image frames and/or a succession of image frames for video. The camera 301 may include an image sensor 302 (including an array of sensor pixels) coupled to a CFA 303 (with each filter of the CFA 303 associated with a different sensor pixel of the image sensor 302). In some implementations, the CFA 303 is a QCFA. For example, the CFA 303 may be a Bayer QCFA. The camera 301 may include other components not shown, such as one or more lenses, an aperture, a flash, and so on.

The image sensor 302 may be configured for HDR imaging based on capturing one image. For example, a first set of sensor pixels may be associated with a first size exposure window, and a second set of sensor pixels may be associated with a second size exposure window. In some implementations, the image sensor 302 may also include a third set of sensor pixels associated with a third size exposure window. The first size exposure window may be the shortest exposure window, and may be referred to as a short exposure window (or S or S exposure window). The second size exposure window may be longer than the short exposure window. If a third set of sensor pixels have a third size exposure window, the second size exposure window may be shorter than the third size exposure window. The second size exposure window may be referred to as a medium exposure window (or M or M exposure window). The third size exposure window may be longer than both the S and the M, and may be referred to as a long exposure window (or L or L exposure window). In some implementations, an S plus an M equal an L. In other words, the L may be divided into an S and an M. For example, an L may be from time t1 to time t3 for an image frame, an M may be from time t1 to time t2 for the image frame, and an L may be from time t2 to time t3 for the image frame. Since S is the shortest exposure window, blur caused by motion may be smallest for the image data captured using an S than for the image data captured using an M or an L.

If the CFA 303 is a Bayer QCFA, each sensor pixel associated with each 2×2 patch of same color filters in a tile may be configured with one of an S, M, or L for capturing image data. For example, for each of the four sensor pixels associated with each patch, one sensor pixel may be associated with an S (with its photodiode exposed the shortest amount of time from the four sensor pixels), two sensor pixels may be associated with an M (with their photodiodes exposed a longer amount of time that for an S but a shorter amount of time than for an L), and one sensor pixel may be associated with an L (with its photodiode exposed the longest amount of time from the four sensor pixels) for capturing image data. As used herein, a sensor pixel being associated with an exposure window size may be referred to as the sensor pixel having the exposure window size (such as a “sensor pixel being associated with an S” being referred to as a “sensor pixel having an S” or an “S sensor pixel”).

The memory 306 may be a non-transient or non-transitory computer readable medium storing computer-executable instructions 308 to perform all or a portion of one or more operations described herein. The one or more processors 304 may be one or more suitable processors capable of executing scripts or instructions of one or more software programs (such as instructions 308) stored within the memory 306. In some aspects, the one or more processors 304 may be one or more general purpose processors that execute instructions 308 to cause the device 300 to perform any number of functions or operations. In additional or alternative aspects, the one or more processors 304 may include integrated circuits or other hardware to perform functions or operations without the use of software. In some implementations, the one or more processors 304 may include an application processor for executing instructions to cause the device 300 to perform one or more applications. For example, if the device 300 is a smartphone and the instructions 308 include instructions for a camera application, an application processor may execute the instructions for the camera application to cause the smartphone to open and execute a camera application (including initializing the camera 301, displaying a preview, displaying a graphical user interface for the user to interact with the smartphone to generate one or more images, and so on). The one or more processors 304 may also provide instructions to the camera controller 310 to control the camera 301 or the one or more image signal processors 312 (such as initializing the camera, performing an autofocus operation, an autoexposure operation, or an automatic white balance operation, initializing one or more filters of one or more image signal processors 312 or other components of the image processing pipeline, and so on).

While shown to be coupled to each other via the one or more processors 304 in the example of FIG. 3, the one or more processors 304, the memory 306, the camera controller 310, the optional display 314, and the optional I/O components 316 may be coupled to one another in various arrangements. For example, the one or more processors 304, the memory 306, the camera controller 310, the display 314, and/or the I/O components 316 may be coupled to each other via one or more local buses (not shown for simplicity).

The display 314 may be any suitable display or screen allowing for user interaction and/or to present items for viewing by a user (such as final images, video, a preview image, and so on). In some aspects, the display 314 may be a touch-sensitive display. The I/O components 316 may be or include any suitable mechanism, interface, or device to receive input (such as commands) from the user and to provide output to the user. For example, the I/O components 316 may include (but are not limited to) a graphical user interface, keyboard, mouse, microphone and speakers, and so on. The display 314 and/or the I/O components 316 may provide a preview image to a user and/or receive a user input for adjusting one or more settings of the camera 301 (such as selecting and/or deselecting a region of interest of a displayed preview image for an autofocus operation).

The camera controller 310 may include one or more image signal processors 312. The one or more image signal processors 312 may be one or more image signal processors to process captured image data from the image sensor 302. As used herein, the one or more image signal processors 312 may be also be referred to as the image signal processor 312 or the ISP 312. In some example implementations, the camera controller 310 (such as the one or more image signal processors 312) may also control operation of the camera 302. In some aspects, the one or more image signal processors 312 may execute instructions from a memory (such as instructions 308 from the memory 306 or instructions stored in a separate memory coupled to the one or more image signal processors 312) to process image data from the camera 301. In other aspects, the one or more image signal processors 312 may include specific hardware to process captured image data from the camera 301. The one or more image signal processors 312 may alternatively or additionally include a combination of specific hardware and the ability to execute software instructions. As noted above, the one or more image signal processors 312 may be part of the image processing pipeline to process the captured image data to generate a final image. For example, the one or more image signal processors 312 may include filters to be applied to the image data (such as a denoising filter, edge enhancement filter, color balance filter, and so on). In some implementations, the one or more image signal processors 312 may also be configured to perform a multi-exposure deblurring process (which may also be referred to as “QCFA deblurring”). In some other implementations, the multi-exposure deblurring may be performed by another component of the image processing pipeline between the image sensor 302 and the one or more image signal processors 312 (such as in a separate processor, one or more application specific integrated circuits (ASICs), and so on). While “QCFA deblurring” is used in the following examples and the examples use a Bayer QCFA as the example QCFA, QCFA deblurring may also refer to multi-exposure deblurring for which the CFA 303 is not a QCFA. QCFA deblurring may also refer to multi-exposure deblurring for which the CFA 303 is a different type of QCFA than a Bayer QCFA. Therefore, the deblurring techniques are not limited to deblurring image data captured by an image sensor coupled to a specific type of QCFA (such as a Bayer QCFA).

The disclosure may describe a device or system component in the singular, but more than one component may be contemplated in describing a device or system component in the singular. For example, a camera 301 may correspond to one camera or a plurality of cameras, a processor 304 may correspond to one processor or a plurality of processors, a memory 306 may correspond to one memory or a plurality of memories, an image signal processor 312 may correspond to one image signal processor or a plurality of image signal processors, and so on. While the following examples, operations, processes, and methods are described with reference to the device 300 in FIG. 3, any suitable device, system, or configuration of components may be used to perform aspects of the disclosure.

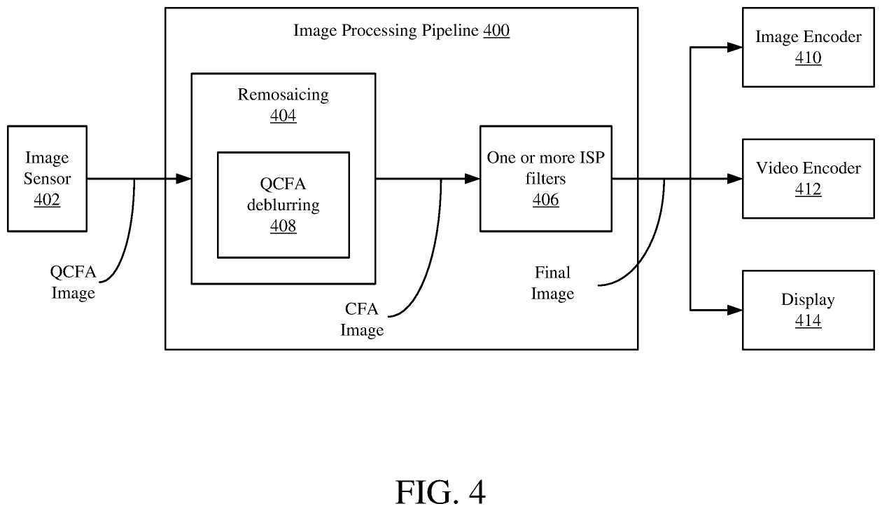

FIG. 4 is a block diagram of an example image processing pipeline 400. A block depicted in the image processing pipeline 400 may indicate one or more processes to be performed or one or more components performing a process. For example, the image processing pipeline 400 includes remosaicing 404. Remosaicing 404 may refer to the image processing pipeline 400 performing remosaicing on a QCFA image received from the image sensor 402. As used herein, a QCFA image may refer to image data for the sensor pixels of the image sensor 402 coupled to a QCFA. An image sensor coupled to a QCFA may be referred to as a QCFA image sensor. The QCFA image includes a pixel value for each of the sensor pixels of the image sensor 402. In some implementations, one or more components may convert the information generated by the image sensor to the QCFA image. For example, the image sensor 402 may output electrical current levels or voltage levels for each sensor pixel. One or more components may convert the electrical current levels or voltage levels to digital values of the QCFA image. The image processing pipeline also includes one or more ISP filters 406. The one or more ISP filters 406 may refer to filters applied by the one or more image signal processors 312 (FIG. 3). The image processing pipeline 400 may include other components or processes not shown (such as an imaging front end to apply a gain and convert voltage levels to digital values, one or more filters outside of the ISP, and so on).

As depicted, the QCFA image may be remosaiced (404) into a CFA image. As used herein, a CFA image may refer to image data after binning or otherwise combining pixel values from the QCFA image. In one example, remosaicing 404 may include remosaicing from a Bayer QCFA image to a Bayer CFA image based on combining pixel values of sensor pixels associated with each patch of each tile of the QCFA image. In some implementations, remosaicing 404 may be performed for HDR imaging (with different sets of sensor pixels of the image sensor 402 having different size exposure windows).

Remosaicing 404 (such as for HDR imaging) may include performing QCFA deblurring 408. As noted above, QCFA deblurring 408 may be performed after capture of image data by the image sensor 402 and applying one or more ISP filters 406 to the image data. In this manner, the image data of the CFA image may be deblurred based on performing QCFA deblurring 408. As used herein, a pixel value of an image generated from performing QCFA deblurring 408 may be referred to as a deblurred pixel value, and an image generated from performing QCFA deblurring 408 may be referred to as a deblurred image. For example, the CFA image in FIG. 4 may be referred to as a deblurred CFA image. While an image being “deblurred” may infer that all blur is removed in the image, as used herein, an image being “deblurred” may refer to blur being reduced (or removed) in the image based on performing QCFA deblurring. For example, a deblurred CFA image refers to a CFA image for which blur is reduced during remosaicing 404 (which includes performing QCFA deblurring 408). If QCFA deblurring is performed during remosaicing, performing deblurring is not limited to being performed by a separate deblurring filter of the one or more ISP filters 406.

One or more ISP filters 406 are applied to the CFA image after remosaicing 404 to generate a final image. In some implementations, the final image may be provided by the image processing pipeline 400 to an image encoder 410 (for encoding the final image), a video encoder 412 (for encoding a video including a sequence of final images), or a display 414 (for immediate display). While not shown, in some implementations, the final image may be provided to a memory for storage or provided to another device for processing, encoding, or storage.

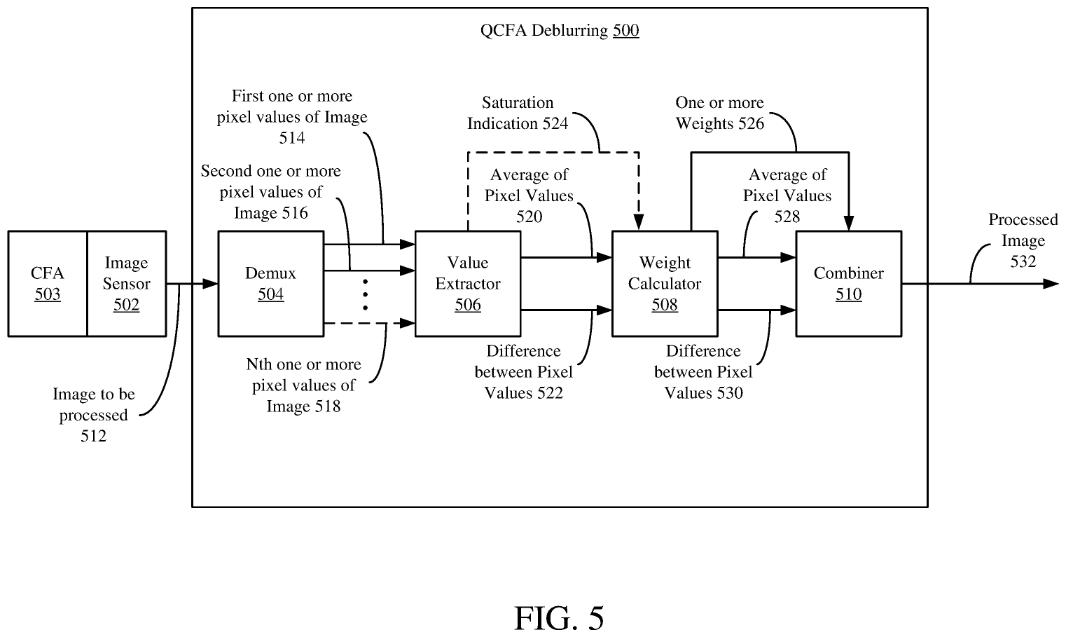

FIG. 5 is a block diagram of an example QCFA deblurring process 500. The QCFA deblurring process 500 may be an example implementation of QCFA deblurring 408 during remosaicing 404 in FIG. 4. The QCFA deblurring process 500 may include a demultiplexer (demux) 504, a value extractor 506, a weight calculator 508, and a combiner 510. The components 504-510 (and any other components of the QCFA deblurring process 500 not shown) may be performed in hardware (such as ASICs or a memory), software executed by one or more processors (such as the one or more image signal processors 312 in FIG. 3), or a combination of hardware and software.

The QCFA deblurring process 500 is configured to receive an image to be processed 512 and output a processed image 532. For example, the QCFA deblurring process 500 begins with receiving a QCFA image and ends with outputting a CFA image for which QCFA deblurring has been performed. The image to be processed 512 may be received from the image sensor 502 coupled to a CFA 503. The image sensor 502 may be an example implementation of the image sensor 302 in FIG. 3 or the image sensor 402 in FIG. 4. The CFA 503 may be an example implementation of the CFA 303 in FIG. 3.

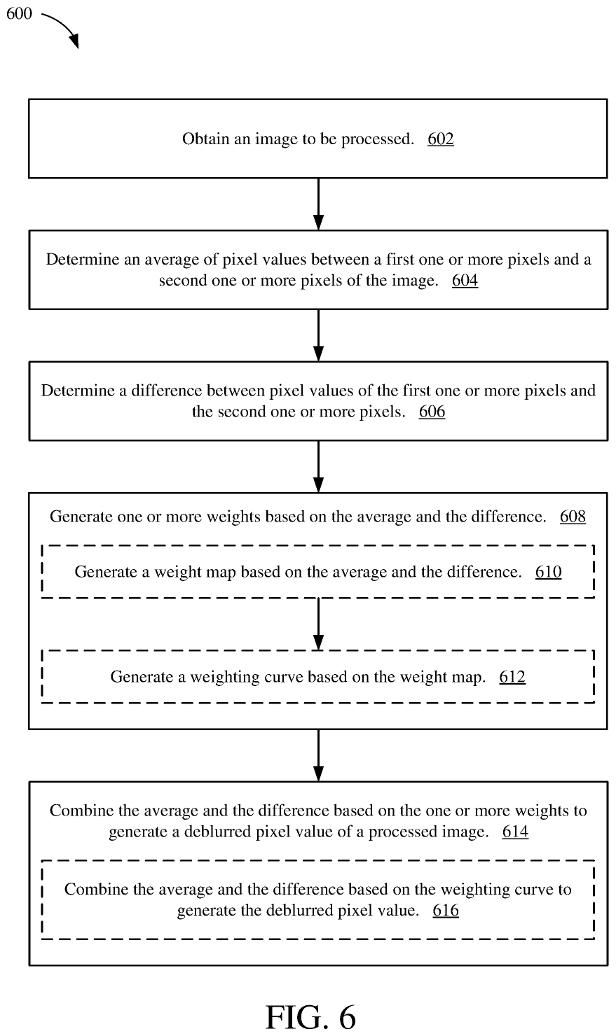

In some other implementations, the image to be processed may be received from a memory, another device, and so on. For example, the QCFA deblurring process 500 may be configured to be applied to an image previously captured and stored. The examples may refer to the image to be processed 512 as a QCFA image. While the examples refer to the image to be processed 512 as a QCFA image, the QCFA deblurring process 500 may be configured to be applied to any suitable image (including a received CFA image captured by an image sensor coupled to a CFA that is not a QCFA). The example may also refer to or depict the QCFA as a Bayer QCFA. While the examples depict a Bayer QCFA, the QCFA deblurring process 500 may also be configured to be applied to any suitable QCFA image that is not a Bayer QCFA image. The processed image 532 may be referred to or depicted as a CFA image (such as after remosaicing a received QCFA image). While the examples refer to or depict a CFA image, any suitable format for a processed image 532 may be output by applying the QCFA deblurring process 500. While the examples depict a Bayer CFA image as the CFA image output, applying the QCFA deblurring process 500 may cause an output of any suitable CFA image (such as a CFA image that is not a Bayer CFA image). An example operation of the QCFA deblurring process 500 is described below with reference to the illustrative flow chart in FIG. 6.

FIG. 6 is an illustrative flow chart depicting an example operation 600 for performing QCFA deblurring 500. The example operation 600 for performing QCFA deblurring 500 is described as being performed by the ISP 312 (FIG. 3). However, the example operation 600 for QCFA deblurring 500 may be performed by any suitable component of the device 300 (such as the processor 304 or a device component between the image sensor 302 and the ISP 312, which is not shown in FIG. 3). At 602, the ISP 312 obtains the image to be processed. In some implementations, the image to be processed is from the image sensor 502 coupled to the CFA 503 (FIG. 5). In some other implementations, the image may be from a memory or another component storing a previously captured image. In some implementations, the image may be a QCFA image (such as a Bayer QCFA image). In some other implementations, the image may be any other suitable CFA image.

A CFA image refers to image data from an image sensor coupled to a CFA. For example, a QCFA image refers to image data from an image sensor coupled to a QCFA. The QCFA image includes a plurality of pixel values associated with the array of sensor pixels of the image sensor. For example, the sensor pixel may provide an electrical current or voltage level indicating a measurement of the light at the sensor pixel. The pixel value may be a digital value corresponding to the electrical current or voltage level. In this manner, an image to be processed may be conceptualized as an array of pixel values corresponding to the array of sensor pixels of the image sensor 502.

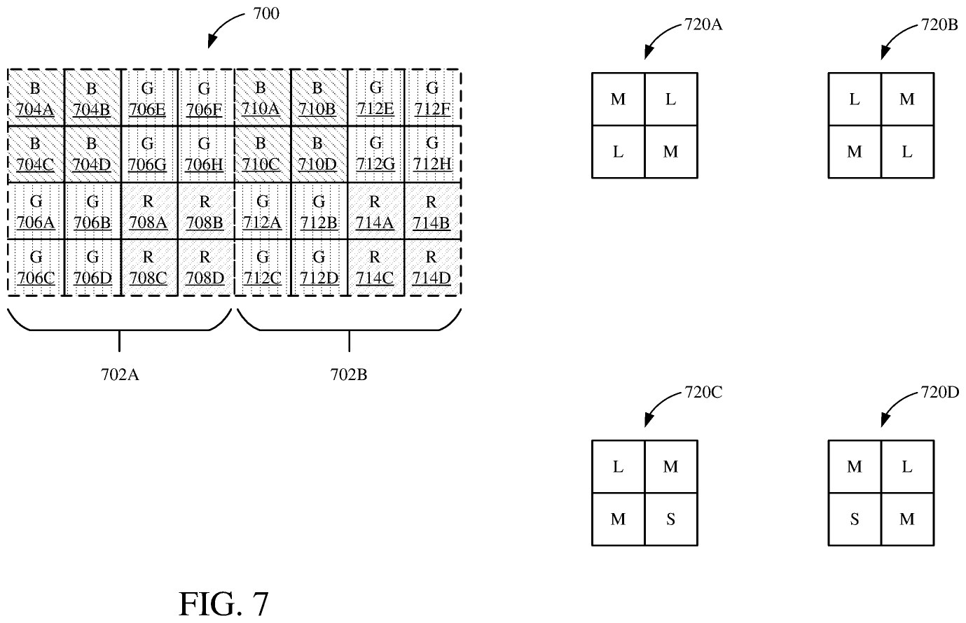

With each sensor pixel coupled to a color filter of the CFA 503, each pixel value of the image is associated with a color. Also, each sensor pixel has an exposure window size for each image frame, and the pixel value is associated with the exposure window size. FIG. 7 is an example portion 700 of an example Bayer QCFA image conceptualized as an array of pixel values. The portion 700 includes a 4×8 array of pixel values corresponding to sensors pixels of the image sensor coupled to two tiles of a Bayer QCFA. A first portion 702A corresponds to sensor pixels coupled to a first tile of a Bayer QCFA, and a second portion 702B corresponds to sensor pixels coupled to a second tile of the Bayer QCFA. The first portion 702A may be referred to as a first tile of the image, and the second portion 702B may be referred to as a second tile of the image. Each tile of the image includes patches of pixel values. For example, a patch of B pixel values 704A-704D corresponds to a 2×2 patch of sensor pixels coupled to a 2×2 patch of B filters of a first Bayer QCFA tile (with the B pixel values 704A-704D associated with a blue color), a patch of G pixel values 706A-706D corresponds to a 2×2 patch of sensor pixels coupled to a first 2×2 patch of G filters of the first Bayer QCFA tile (with the G pixel values 706A-706D associated with a green color), a patch of G pixel values 706E-706H corresponds to a 2×2 patch of sensor pixels coupled to a second 2×2 patch of G filters of the first Bayer QCFA tile (with the G pixel values 706E-706H associated with the green color), and a patch of R pixel values 708A-708D corresponds to a 2×2 patch of sensor pixels coupled to a 2×2 patch of R filters of the first Bayer QCFA tile (with the R pixel values 708A-708D associated with a blue color). Patches of pixel values 710A-714D have a similar correspondence to a second Bayer QCFA tile.

The image sensor 502 (FIG. 5) may include sets of sensor pixels having different exposure window sizes. In some implementations, neighboring sensor pixels have different exposure window sizes. In this manner, the image sensor 502 may be associated with two or more exposure window sizes. In some implementations, each patch of pixel values of the image (such as B pixel values 704A-704D, G pixel values 706A-706D, and so on) is associated with two or more exposure window sizes. Example exposure patches 720A-720D depict two or more exposure window sizes associated with each patch of the image. Exposure patch 720A depicts two exposure window sizes M and L associated with a patch of pixel values. For example, if the patch of B pixel values 704A-704D corresponds to the exposure patch 720A, the sensor pixel corresponding to the B pixel value 704A has an M exposure window, the sensor pixel corresponding to the B pixel value 704B has an L exposure window, the sensor pixel corresponding to the B pixel value 704C has the L exposure window, and the sensor pixel corresponding to the B pixel value 704D has the M exposure window. Example exposure patch 720B depicts the two exposure window sizes M and L flipped from the exposure patch 720A.

Exposure patches may also be associated with three exposure window sizes. Example exposure patch 720C depicts three exposure window sizes S, M, and L. Example exposure patch 720D depicts the three exposure window sizes S, M, and L flipped from the exposure patch 720C. While not shown, exposure patches may be associated with four exposure window sizes (or more if the patch is greater than 2×2). In some implementations, each patch of the image is associated with the same exposure patch. While the examples depict each patch being associated with the same exposure patch (thus each patch of the image is captured using the same pattern of exposure window sizes), in some other implementations, different patches of the image may be associated with different exposure patches (thus two or more patches of the image may be captured using different patterns of exposure window sizes). While some example exposure patches are depicted, any suitable size and configuration of an exposure patch may be used. Also, while the examples refer to exposure window sizes S, M, and L in describing the QCFA deblurring filter 500 (FIG. 5), any suitable exposure window sizes may be used. Referring back to FIG. 5, the image to be processed includes an array of pixel values, with each pixel value associated with a color and an exposure window size (such as a QCFA image resembling the portion 700 in FIG. 7).

Referring back to FIG. 6, the ISP 312 determines an average of pixel values between a first one or more pixels and a second one or more pixels of the image 512 (604). The ISP 312 also determines a difference between pixel values of the first one or more pixel values and the second one or more pixel values (606). The one or more pixels having the second one or more pixel values neighbor the one or more pixels having the first one or more pixel values in the image 512. For example, a first one or more pixels and a second one or more pixels of the image 512 may be from the same patch of the image 512 (such as from a patch of B pixel values 704A-704D in FIG. 7 or other patches of the image).

In some implementations of steps 604 and 606, a demux 504 (FIG. 5) is applied to separate each patch of pixel values into a first one or more pixel values 514 and a second one or more pixel values 516. Applying the demux 504 may also separate the patch into additional one or more pixel values (up to an Nth one or more pixel values 518). In some implementations, each of the one or more pixel values 514, 516, and so on are associated with a similar exposure window size. “Applying a demux” as used herein may also be referred to as “demultiplexing.”

In one example, if the patch of B pixel values 704A-704D (FIG. 7) is associated with the exposure patch 720B and is to be separated, applying the demux 504 may separate the patch into first B pixel values 702A and 702D (associated with an M exposure window) and second B pixel values 702B and 702C (associated with an L exposure window). In another example, applying the demux 504 may separate the patch into a first B pixel value 702A or 702D and a second B pixel value 702B or 702C. In this manner, one or more pixel values of the patch may not be used for QCFA deblurring. For example, one or more pixel values of the patch may not be provided by applying the demux 504 for the value extractor 506 of the QCFA deblurring process 500. In some implementations, applying the demux 504 may ignore or otherwise not provide pixel values associated with an S exposure window. For example, if the patch of B pixel values 704A-704D is associated with the exposure patch 720D, applying the demux 504 may not provide the B pixel value 702C for the value extractor 506. In this manner, QCFA deblurring 500 may be based on two exposure window sizes (even if a patch of the image is associated with more than two exposure window sizes). In some other implementations, applying the demux 504 may cause other pixel values associated with other exposure window sizes to be provided for the value extractor 506 (such as an S exposure window or other suitable exposure window size). In this manner, QCFA deblurring 500 may be based on more than two exposure window sizes.

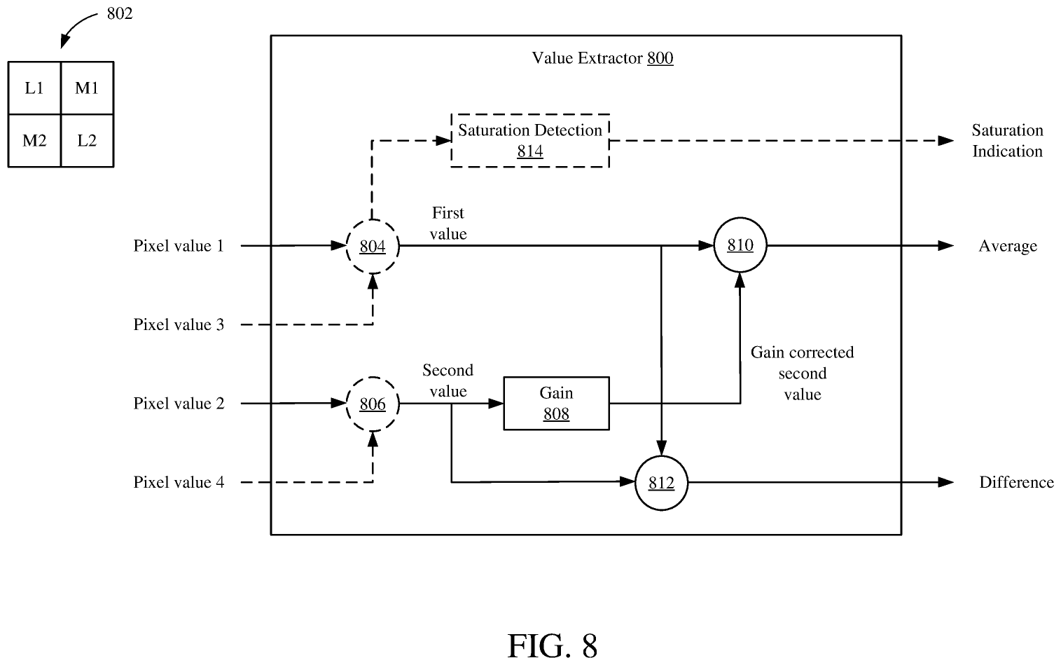

The ISP 312 (FIG. 3) may apply the value extractor 506 to determine the average (604) and to determine the difference (606) of the received pixel values from applying the demux 504. FIG. 8 is a block diagram of an example value extractor 800. The value extractor 800 may be an example implementation of the value extractor 506 in FIG. 5 (which may be applied by the ISP 312 in FIG. 3 or another suitable device component). While the value extractor 800 is described with reference to a Bayer QCFA image (similar to the portion 700 in FIG. 7), with reference to each patch of the image corresponding to exposure patch 720B in FIG. 7 (associated with M and L exposure windows), and with reference to applying the demux 504 (FIG. 5) to cause specific pixel values of the first one or more pixel values and the second one or more pixel values to be provided, any suitable CFA image, any suitable exposure patch (or patches) associated with suitable exposure window sizes, and any suitable pixel values provided in applying the demux 504 may be used.

Example exposure patch 802 may correspond to each patch of a Bayer QCFA image (such as the image to be processed 512 in FIG. 5). The exposure patch 802 is similar to example exposure patch 702B in FIG. 7. In the example implementation in FIG. 8, the ISP 312 (in applying the demux 504 in FIG. 5) is configured to separate and provide at least pixel value 1 for the first one or more pixel values and pixel value 2 for the second one or more pixel values. Each of the first one or more pixel values are associated with a first exposure window size (such as L), and each of the second one or more pixel values are associated with a second exposure window size smaller than the first exposure window size (such as M). Referring to the exposure patch 802, the pixel value 1 may correspond to L1 exposure window size, and the pixel value 2 may correspond to M1 exposure window size. In some implementations, applying the demux 504 may also provide pixel value 3 for the first one or more pixel values and pixel value 4 for the second one or more pixel values. Referring to the exposure patch 802, the pixel value 3 may correspond to L2 exposure window size, and the pixel value 4 may correspond to M2 exposure window size. In some other implementations, only pixel values 1 and 2 may be used (and pixel values 3 and 4 may be ignored in performing QCFA deblurring 500 in FIG. 5). If the exposure window 802 corresponds to the patch of B pixel values 704A-704D (FIG. 7) when applying the demux 504 (separating the pixel values from the patch of B pixel values into the first and second one or more pixel values), applying the demux 504 may cause at least the B pixel value 704A for the first one or more pixel values and at least the B pixel value 704B for the second one or more pixel values to be provided for the value extractor 506. Applying the demux 504 may also cause the B pixel value 704D for the first one or more pixel values and the B pixel value 704C for the second one or more pixel values to be provided for the value extractor 506. As depicted in FIG. 7, the B pixel values 704A and 704D neighbor the B pixel values 704B and 704C. Applying the demux 504 may be applied patch by patch in separating the image 512, providing the different one or more pixel values for each patch. For the below examples, the four pixel values for each patch corresponding to the exposure patch 802 may be referred to as L1, M1, M2, and L2 (which may correspond to exposure window sizes L1 (an L), M1 (an M), M2 (an M), and L2 (an L) as noted above). For example, pixel value 1 may be referred to as L1, pixel value 2 may be referred to as M1, pixel value 3 may be referred to as L2, and pixel value 4 may be referred to as M2. If each patch of the image 512 is greater than 2×2 (with each patch associated with a larger exposure patch than exposure patch 802), demultiplexing may cause more than four pixel values to be provided (which may be used for the value extractor 800 in generating an average and a difference).

If applying the demux 504 does not cause pixel value 3 to be provided, the first value is pixel value 1. If the demux 504 causes pixel value 3 to be provided for the value extractor 800, the ISP 312 may apply component 804 to combine pixel value 1 and pixel value 3 to generate the first value. For example, component 804 may include averaging pixel value 1 and pixel value 3, as depicted in equation (2) below:

$$First Value = \frac{Pixel value 1 + Pixel value 3}{2} \qquad ( 2 )$$

If pixel value 1 and pixel value 3 are associated with an L exposure window, the first value is associated with an L exposure window. In this manner, equation (2) may be written as depicted in equation (3) below:

$${L}_{AVG} = \frac{L 1 + L 2}{2} \qquad ( 3 )$$

L_{AVG} is the First Value associated with the L exposure window, L1 is pixel value 1 associated with the L exposure window, and L2 is pixel value 3 associated with the L exposure window.

If applying the demux 504 does cause pixel value 4 to be provided, the second value is pixel value 2. If applying the demux 504 causes pixel value 4 to be provided for the value extractor 800, the ISP 312 may apply component 806 to combine pixel value 2 and pixel value 4 to generate the first value. For example, component 806 may include averaging pixel value 2 and pixel value 4, as depicted in equation (4) below:

$$Second Value = \frac{Pixel value 2 + Pixel value 4}{2} \qquad ( 4 )$$

If pixel value 2 and pixel value 4 are associated with an M exposure window, the second value is associated with an M exposure window. In this manner, equation (4) may be written as depicted in equation (5) below:

$${M}_{AVG} = \frac{M 1 + M 2}{2} \qquad ( 5 )$$

M_{AVG} is the Second Value associated with the M exposure window, M1 is pixel value 2 associated with the M exposure window, and M2 is pixel value 4 associated with the M exposure window.

The ISP 312 applies component 812 to determine a difference between the first value and the second value, such as depicted in equation (6) below:

Difference=First value−Second value (6)

If the first value corresponds to an L exposure window and the second value corresponds to an M exposure window (such as in equations (3) and (5) above), equation (6) may be rewritten as depicted in equation (7) below:

Difference=L_{AVG}−M_{AVG} (7)

The output “difference” depicted in FIG. 8 may be an example implementation of the difference 522 in FIG. 5.

Since the first one or more pixel values and the second one or more pixel values correspond to different exposure window sizes (such as an L exposure window for the first one or more pixel values and an M exposure window for the second one or more pixel values), the difference indicates a difference in pixel values corresponding to the difference in exposure window sizes (such as pixel values corresponding to an L exposure window versus pixel values corresponding to an M exposure window).

The ISP 312 applies component 810 to generate the average of pixel values between the first one or more pixel values and the second one or more pixel values. Since the first one or more pixel values and the second one or more pixel values correspond to different exposure window sizes (such as the first one or more pixel values being captured using an L exposure window and the second one or more pixel values being captured using an M exposure window), the pixel values may not directly correspond between one another in the patch. To compensate for the difference in exposure window sizes, the ISP 312 may apply a gain component 808 to adjust the second one or more pixel values. For example, the gain component 808 includes applying a gain to adjust the second value to compensate for the difference between the first exposure window size and the second exposure window size (such as increasing the second value to compensate for a different in size between an M exposure window and an L exposure window). In some implementations, applying the gain component 808 includes applying a factor to the second value to generate the gain corrected second value, such as depicted in equation (8) below:

Gain corrected second value=Second value*Gain factor (8)

The gain factor may be as depicted in equation (9) below:

$$Gain factor = \frac{First exposure window size}{Second exposure window size} \qquad ( 9 )$$

If the first value corresponds to an L exposure window and the second value corresponds to an M exposure window, equation (9) may be rewritten as depicted in equation (10) below:

$$Gain factor = \frac{L}{M} \qquad ( 10 )$$

The ISP 312 may apply component 810 to generate the average by averaging the first value and the gain corrected second value, such as depicted in equation (11) below:

$$Average = \frac{First value + Gain corrected second value}{2} \qquad ( 11 )$$

If the first value corresponds to an L exposure window and the second value corresponds to an M exposure window, equation (11) may be rewritten as depicted in equation (12) below:

$$Average = \frac{First value + ( Second value * \frac{L}{M} )}{2} \qquad ( 12 )$$

The output “average” depicted in FIG. 8 may be an example implementation of the average 520 in FIG. 5.

As described in more detail below, the average and the difference outputs may be combined to generate a deblurred pixel value. In some implementations of combining the average and the difference, the ISP 312 performs a weighted average of the two values. Weighting the two values may be based on whether there exists motion (or an amount of motion existing) to cause motion blur in the image (such as when objects in the scene moves of the camera moves). For example, a difference (such as from equation (7)) may be given greater weight and an average (such as from equation (12)) may be given lesser weight for a weighted average when motion in the scene increases. The difference (such as from equation (7)) may be given lesser weight and an average (such as from equation (12)) may be given greater weight for a weighted average when motion in the scene decreases. In using the average and the difference in generating the deblurred pixel value, the ISP 312 may be able to indicate or otherwise separate portions of the image from the image sensor 302 including more motion blur than portions of the image including less motion blur. In some implementations, regions of the image including less than a threshold amount of motion blur may be referred to as stationary regions, and regions of the image including greater than the threshold amount of motion blur may be referred to as motion regions.

The image 512 may include one or more pixel values that are saturated. For example, a sensor pixel's photodiode may receive an amount of light greater than can be measured by the photodiode during one exposure window. In this manner, the sensor pixel may output a maximum value that may indicate that more light is received during the exposure window than can be measured at the sensor pixel. In some implementations, QCFA deblurring 500 may be based on the first one or more pixel values and the second one or more pixel values not being saturated. For example, QCFA deblurring 500 may not be performed for a pixel of the processed image in response to detecting a saturation of one or more pixel values of the image 512 that would be used in performing QCFA deblurring 500 for the pixel of the processed image 532.

Referring back to FIG. 8, the ISP 312 applying the value extractor 800 may include detecting whether the first one or more pixel values are saturated. In some implementations, the saturation detection component 814 determines whether pixel value 1 is saturated or pixel value 2 is saturated. The ISP 312 may apply the saturation detection component 814 to pixel value 1 (and optionally pixel value 3) instead of pixel value 2 or pixel value 4 since the first exposure window size is greater than the second exposure window size. Since the first exposure window size is greater than the second exposure window size, pixel value 1 and pixel value 3 are more likely to be saturated than pixel value 2 and pixel value 4. In some implementations, applying the saturation detection component 814 includes determining whether pixel value 1 or pixel value 3 is a maximum value that may be provided for any pixel in the image 512. If saturation is detected, the ISP 312 (in applying the saturation detection component 814) may generate a saturation indication. The output “saturation indication” depicted in FIG. 8 may be an example of the saturation indication 524 in FIG. 5. In some other implementations, the ISP 312, in performing QCFA deblurring 500, may not account for saturation. In this manner, the ISP 312, in applying the value extractor 506, may not provide a saturation indication 524 even when pixel value 1 and/or pixel value 3 is saturated.

In applying the value extractor 800 for each patch of an image 512 (FIG. 5) to generate an average and a difference, the ISP 312 may output a plurality of averages (that may be conceptualized as an array of averages) and a plurality of differences (that may be conceptualized as an array of differences). For example, the averages output by the ISP 312 for the image 512 (such as by applying the value extractor 800) may be a plurality of averages including an average corresponding to each patch of each tile of the image 512 (FIG. 5). Similarly, the differences output by the ISP 312 for the image 512 (such as by applying the value extractor 800) may be a plurality of differences including a difference corresponding to each patch of each tile of the image 512 (FIG. 5). The processed image 532 output by performing QCFA deblurring 500 may thus be conceptualized as an array of pixel values, with each pixel value corresponding to a different patch of the image 512 and the pixel value being determined based on the difference and the average corresponding to the patch of the image 512. For example, a pixel value of the processed image 532 may be a deblurred pixel value based on one or more weights 526 determined from the averages and the differences. In some implementations, the one or more weights 526 may be used to determine how to combine the average and the difference to generate a deblurred pixel value. For example, the one or more weights 526 may be used to determine a weight associated with the difference and a weight associated with the average for a weighted average.

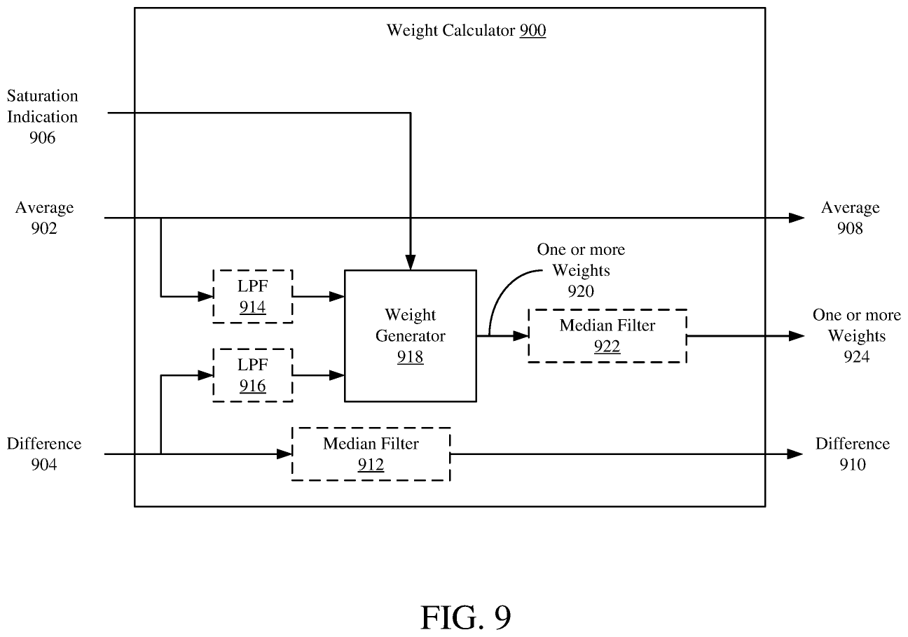

Referring back to FIG. 6, the ISP 312 (in performing QCFA deblurring 500) generates one or more weights 526 based on the average and the difference (608). In some implementations, the ISP 312 generates a weight map including the one or more weights (610). Referring back to FIG. 5, the ISP 312 may apply the weight calculator 508 to generate the one or more weights (such as the weight map). FIG. 9 is a block diagram of an example weight calculator 900. The weight calculator 900 may be an example implementation of the weight calculator 508 in FIG. 5. The ISP 312, in applying the weight calculator 900, may be configured to determine whether a patch of the image 512 includes or does not include motion information in its pixel values (such as whether the patch is a motion region or a stationary region of the image 512). In some examples, the ISP 312, in applying the weight calculator 900), may determine or indicate a magnitude of motion in the patch's pixel values. As noted above, determining whether motion information is included (and a magnitude of the motion information) in the pixel values of a patch may be based on the average and the difference determined for the patch of the image 512. The first value generated in applying the value extractor 800 (FIG. 8) is associated with a first exposure window size, and the second value generated in applying the value extractor 800 is associated with a smaller, second window size. The second value may include less motion information than the first value since the second exposure window associated with the second value is smaller than the first exposure window associated with the first value (and thus less time passes for motion to occur in the scene portion). The average and the difference may thus include information regarding whether motion information exists (and the magnitude of the motion information) in the patch of pixel values from the image 512 (FIG. 5). The ISP 312, in applying the weight calculator 900, may process the average and the difference to determine whether the patch's pixel values include motion information (and the magnitude of the motion information). As used herein, motion information may refer to a change or offset in a pixel value as a result of motion. The motion information may also be referred to as motion blur.

Referring back to FIG. 9, the ISP 312, in applying the weight calculator 900, uses an average 902 and a difference 904 to generate or output an average 908, a difference 910, and one or more weights 924. The average 902 and the difference 904 are an example implementation of the average 520 and the difference 522 in FIG. 5 and an example implementation of the average and the difference output in applying the value extractor 800 in FIG. 8. The average 902 may include an average for each patch of the image to be processed, and the difference 904 may include a difference for each patch of the image to be processed. The average 908, the difference 910, and the one or more weights 924 are an example implementation of the average 528, the difference 530, and the one or more weights 526 in FIG. 5. In some implementations, the ISP 312 may also use a saturation indication 906 in applying the weight calculator 900. The saturation indication 906 may be an example implementation of the saturation indication 524 in FIG. 5 and an example implementation of the saturation indication output in applying the value extractor 800 in FIG. 8.

The average 908 may equal the average 902 (as depicted), and the difference 904 may equal the difference 910. However, the difference 904 (which may be conceptualized as an array of difference values corresponding to the array of patches of the image 512 in FIG. 5) may include salt and pepper noise. In some implementations, the ISP 312 applies a median filter 912 to the difference 904 to generate the difference 910 (which includes reduced salt and pepper noise). Any suitable median filter may be applied to the difference 904.

The ISP 312 may apply the weight generator 918 to generate one or more weights 920 based on the average 902 and the difference 904. In some implementations, each of the one or more weights 920 may correspond to a patch of the image 512 in FIG. 5. As noted above, the average 902 may be conceptualized as an array of averages corresponding to the array of patches of the image 512 in FIG. 5. The difference 904 may be conceptualized as an array of differences corresponding to the array of averages. The array of averages may be referred to as a total average, and the array of differences may be referred to as a total difference.

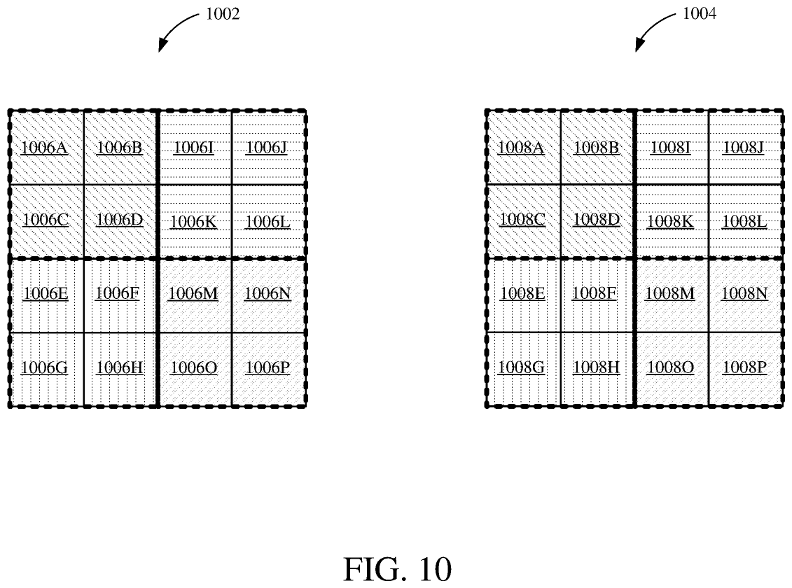

FIG. 10 is a depiction of example portions of a total average 1002 and a corresponding total difference 1004. The total average 1002 and the total difference 1004 may be determined by the ISP 312 in applying the value extractor 506 in FIG. 5 to the image 512. The portion of the total average 1002 includes averages 1006A-1006P. The portion of the total difference 1004 includes differences 1008A-1008P. The difference 1008A may correspond to the average 1006A, the difference 1008B may correspond to the average 1006B, and so on. If the CFA 503 is a QCFA (such as a Bayer QCFA), the depicted portions of the total average 1002 and the total difference 1004 may correspond to four tiles of the image 512 in FIG. 5. For example, each average 1006A-1006P is the average determined for a different patch of the image 512 in FIG. 5, and each difference 1008A-1008P is the difference determined for the corresponding patch. Averages 1006A-1006D and differences 1008A-1008D may correspond to a first tile (including four patches) of the image 512, averages 1006E-1006H and differences 1008E-1008H may correspond to a second tile (including four patches) of the image 512, averages 1006I-1006L and differences 1008I-1008L may correspond to a third tile (including four patches) of the image 512, and averages 1006M-1006P and differences 1008M-1008P may correspond to a fourth tile (including four patches) of the image 512. The size of the total average 1002 and the total difference 1004 may be the size of the array of patches of the image 512.

The average 902 (as an array of averages) may include one or more outliers (such as a value more than a threshold away from one or more other neighboring values in the array). In some implementations, the ISP 312 applying the weight calculator 900 may apply a low pass filter (LPF) 914 to the average 902. In this manner, the ISP 312 may remove an outlier by reducing the difference between the outlier and other neighboring values of the average 902. The difference 904 (as an array of differences) may also include one or more outliers. In some implementations, the ISP 312 applying the weight calculator 900 may apply an LPF 916 to the difference 904. In this manner, the ISP 312 may remove an outlier by reducing the difference in value between the outlier and other neighboring values of the difference 904). The ISP 312, in applying the weight calculator 900, may apply one, both, or neither of LPF 914 and 916. The LPF 914 and the LPF 916 may be the same type of LPF or different types of LPF. In some implementations, the LPF 914 and the LPF 916 are bilateral filters to preserve edges in the array of values while smoothing the values. In some other implementations, the LPF 914 or LPF 916 may include one or more other suitable smoothing, edge-preserving filters, such as anisotropic diffusion, weighted least squares, and so on.

As noted above, the average 902 (or LPF applied average) may be an array of values of the same size as the array of patches in the image 512 (FIG. 5). Similarly, the difference 904 (or LPF applied difference) may be an array of values of the same size as the array of patches in the image 512 (and thus the same size as the average 902). In the description below, the average 902 (as an array of averages) is referred to as a total average, and the difference 904 (as an array of differences) is referred to as a total difference (such as depicted in FIG. 10).

Applying the median filter 912 may include applying a median filter to the total difference 1004 in FIG. 10, applying the LPF 914 may include applying an LPF (such as a bilateral filter) to the total average 1002 in FIG. 10, and applying the LPF 916 may include applying an LPF (such as a bilateral filter) to the total difference 1004 in FIG. 10. The ISP 312 may apply the weight generator 918 to a total average (or LPF applied total average) and a total difference (or LPF applied total difference) to generate the one or more weights 920. The saturation indication 906 may include an indication of saturation of at least one pixel value of the image 512 used to generate a corresponding pair of an average and a difference from the total average and the total difference. For example, if a pixel value in a patch of the image 512 associated with the average 1006I and difference 1008I is saturated, the saturation indication 906 may include an indication of saturation corresponding to the average 1006I and difference 1008I. In some implementations, the total average and the total difference may be output or generated as a sequence of averages from the array of averages and a sequence of differences from the array of differences. When pixel value 1 or pixel value 3 (FIG. 8) is saturated, the ISP 312 (applying the saturation detection component 814) may output a saturation indication corresponding to the average 1006I and the difference 1008I being output.

As noted above, each of the one or more weights 920 may correspond to a patch of the image 512 in FIG. 5. In this manner, each weight of the one or more weights 920 corresponds to an average of the total average and a corresponding difference of the total difference. In some implementations, the one or more weights 920 includes an array of weights corresponding to the array of averages (the total average) and the array of differences (the total difference). The array of weights may be referred to herein as a weight map. In this manner, the weight map may be conceptualized as an array of weights, with each weight corresponding to a pair of an average and a difference from the total average and the total difference. For example, a first weight of the weight map may correspond to average 1006A and difference 1008A in FIG. 10, a second weight of the weight map may correspond to average 1006B and difference 1008B in FIG. 10, and so on. In this manner, the ISP 312, may apply the weight generator 918 to generate each weight for generating the one or more weights 920 (such as a weight map). In some implementations, applying the weight generator 918 includes determining a sum of absolute differences based on the average 902 and the difference 904 to generate a weight of the one or more weights 920.

An example process for generating a weight is described with reference to FIG. 10. A window of averages and a window of differences from the total average 1002 and the total difference 1004 may be used in determining each weight in the one or more weights 920 (FIG. 9). In some implementations, the window of averages may be a 3×3 window centered at the average for which a weight is determined, and the window of differences may be a 3×3 window centered at the average for which the weight is determined. For example, in determining a weight for the average 1006D and the difference 1008D, the window on the total average 1002 may include nine averages: average 1006D and neighboring averages 1006A, 1006B, 1006I, 1006C, 1006K, 1006E, 1006F, and 1006M. The window on the total difference 1004 may include nine differences: difference 1008D and neighboring differences 1008A, 1008B, 1008I, 1008C, 1008K, 1008E, 1008F, and 1008M. While a window of size 3×3 is described in the examples, any suitable size window may be used, and the window may be positioned in any suitable manner. For example, the window may be size 4×4, 3×4, 4×3, 5×5, or any other suitable size. In some examples, the window may be positioned so that the average and difference for which a weight is determined is on a side of the window, a corner of the window, or otherwise not in the center of the window.

From the above example of a 3×3 window, determining the weight corresponding to average 1006D and difference 1008D includes determining a sum of absolute differences using average 1006D and neighboring averages 1006A, 1006B, 1006I, 1006C, 1006K, 1006E, 1006F, and 1006M and using difference 1008D and neighboring differences 1008A, 1008B, 1008I, 1008C, 1008K, 1008E, 1008F, and 1008M. In some implementations, the ISP 312 may first adjust difference 1008D and neighboring differences 1008A, 1008B, 1008I, 1008C, 1008K, 1008E, 1008F, and 1008M in applying the weight generator 918 (FIG. 9). The adjustment may cause the nine differences to have comparable magnitudes to the corresponding average 1006D and neighboring averages 1006A, 1006B, 1006I, 1006C, 1006K, 1006E, 1006F, and 1006M. The adjustment may be the same for each difference, and the adjustment may be based on average 1006D corresponding to the difference 1008D.

An example adjustment to be applied to each difference in the window may be the difference between the average 1006D and the difference 1008D, such as depicted in equation (13) below:

adjustment=average 1006D−difference 1008D (13)

The adjustment is then applied to each difference in the window, such as depicted in equation (14) below:

adjusted difference 1008X′=difference 1008X′+adjustment (14)

for X′ in the set of {A, B, I, C, D, K, E, F, and M}. In the above example, the ISP 312 (applying the weight generator 918 in FIG. 9) generates adjusted differences 1008A′, 1008B′, 1008I′, 1008C′, 1008D′, 1008K′, 1008E′, 1008F′, and 1008M′.

The weight corresponding to average 1006E and difference 1006E may be the sum of absolute differences (SAD), such as depicted in equation (15) below:

SAD_{E}=Σ|average 1006X−adjusted difference 1008X′| (15)

for X′ across the set of {A, B, I, C, D, K, E, F, and M}. For example, SAD_{E}=|average 1006A—adjusted difference 1008A′|+|average 1006B−adjusted difference 1008B′|+ . . . for {A, B, I, C, D, K, E, F, and M}. In determining weights corresponding to other average and difference pairs in the total average 1002 and total difference 1004, the same steps described above may be performed to determine the SAD corresponding to the average and difference pair. In this manner, the ISP 312 (in applying the weight generator 918 in FIG. 9) may determine the one or more weights 920 including the SAD corresponding to one or more average and difference pairs in the total average 902 and the total difference 904. The array of SADs corresponding to the total average 902 and the total difference 904 may be the weight map.

Motion blur in an image 512 may be continuous. For example, if a first portion of the image 512 (FIG. 5) is affected by motion, a neighboring portion of the image 512 is typically affected at least in part by the same motion. As such, it may be undesired to have any outliers between neighboring weights in the one or more weights (such as neighboring weights in a weight map). To smooth any outlier weights, the ISP 312 (in applying the weight calculator 900) may apply a median filter 922 to the one or more weights 920 to generate the one or more weights 924. For example, the ISP 312 may apply the median filter 922 to a generated weight map to output a weight map for use in applying the combiner 510 (FIG. 5). Any suitable median filter may be applied. In some other implementations, the one or more weights 924 may be the same as the one or more weights 920 (with the ISP 312 not applying the median filter 922). In some scenarios or implementations, at least one of the one or more weights 920 may be associated with the saturation indication 906. For example, the ISP 312 may determine that the pixel value 1 or the pixel value 3 (FIG. 8) of the image 512 is saturated, and the saturation indication 906 may indicate the saturation when determining the affected weight of the one or more weights 920. In some implementations, the one or more weights 920 (and the one or more weights 924) may include an indication for each weight affected by saturation. For example, the weight may be set to zero, may be set to a non-number value, or may be set to another suitable, pre-defined value by the ISP 312 instead of determining a SAD (as described above). In another example, the ISP 312 may determine a SAD for the affected weight, and each affected weight may include a flag or other indication that the weight is affected by saturation. In some other implementations, the ISP 312 may ignore saturation, and the saturation indication 906 may not be generated or used by the ISP 312 in performing QCFA deblurring 500.

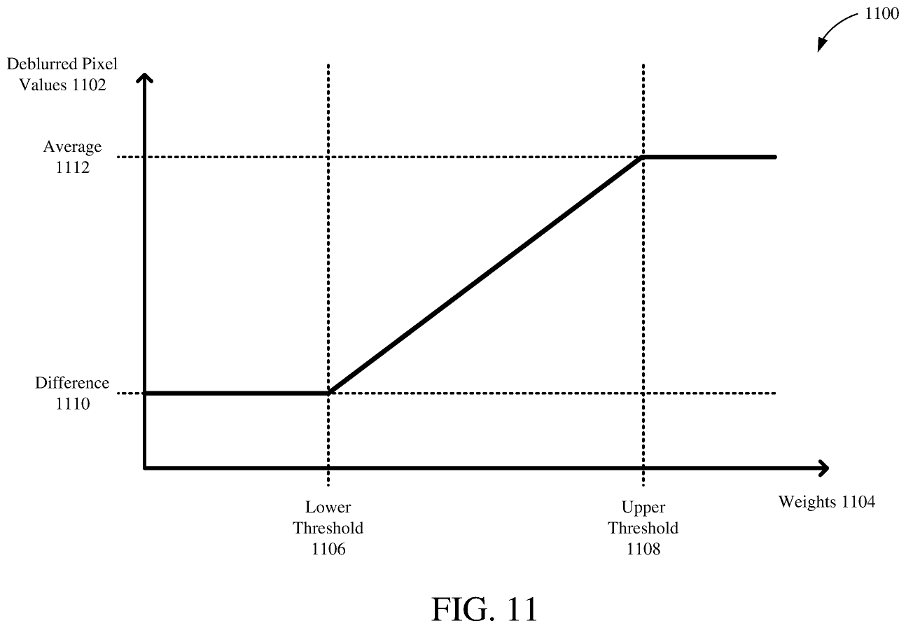

Referring back to FIG. 5, the ISP 312 (in applying the weight calculator 508) generates the one or more weights 526 (such as described above) and provides the one or more weights 526, the average 528 (such as a total average described above), and the difference 530 (such as a total difference described above) for the combiner 510. Referring back to FIG. 6, if the ISP 312 generates the weight map (610), The ISP 312 may generate a weighting curve based on the weight map (612). Generating the weighting curve is described in more detail below with reference to FIG. 11.

The ISP 312, in performing QCFA deblurring 500, combines the average and the difference based on the one or more weights to generate a deblurred pixel value of the processed image 532 (614). In some implementations, the ISP 312 combines the average and the difference based on the weighting curve to generate the deblurred pixel value. Referring back to FIG. 5, the ISP 312 may apply the combiner 510 to generate the weighting curve based on a weight map. The ISP 312 may also apply the combiner 510 to generate the deblurred pixel value based on the weighting curve.

As noted above, a combination of corresponding average and difference may be combined to generate a deblurred pixel value. How the average and the difference are combined may be based on the weight associated with the average and the difference. For example, if the ISP 312 is to perform a weighted average of the average and the difference to generate a deblurred pixel value, the weight determined by the ISP 312 that corresponds to the average and the difference may indicate each weight of the average and the difference for the weighted average. In some implementations, the ISP 312 determines a weighting curve, which is used to determine, based on a weight corresponding to an average and a difference, a combination of the corresponding average and the corresponding difference to generate a deblurred pixel value of the processed image 532. The processed image 532 may be the same size as the total average and the total difference. The processed image 532 may also be the same size as a weight map (if a weight map is generated by the ISP 312). For example, the processed image 532 may be a quarter of the size of the image 512 when remosaicing a QCFA image to a CFA image. The location of the deblurred pixel value in the processed image 532 corresponds to the location of the weight in a generated weight map. In some implementations, the ISP 312 (in applying the combiner 510) determines a position of a weight on the weighting curve and determines the combination of the average and difference based on the position to generate the deblurred pixel value. The process may be repeated to generate each deblurred pixel value of the processed image 532.

In some implementations, the weighting curve may include a lower threshold (or lower threshold weight) and an upper threshold (or upper threshold weight). A lower threshold may be a threshold corresponding to little or no motion information in the associated patch of the image 512 (FIG. 5). In other words, the portion of the scene captured in the patch includes little to no motion (such as below a threshold of motion). In some implementations of combining the average and the difference, if a weight is less than the lower threshold, the corresponding deblurred pixel value is set to the difference. For example, if SAD_{E} in the above example depicted in equation (15) is less than the lower threshold, the deblurred pixel value is set to difference 1008E. SAD_{E} in the above example being less than a lower threshold may indicate that the difference and the average may be similar values across a window. Therefore, pixel values may not vary based on motion blur in the image 512. In this manner, the difference may be used as the deblurred pixel value (which may be associated with a pixel value for the sensor pixel being associated with the S exposure window (L−M=S)).

An upper threshold may be a threshold corresponding to a large amount of motion information (such as greater than a threshold amount of motion information) in the associated patch of the image 512 (FIG. 5). In other words, the portion of the scene captured in the patch includes at least a threshold amount of motion to cause blur. If the weight is greater than the upper threshold, the corresponding deblurred pixel value is set to the average. For example, if SAD_{E} in the above example depicted in equation (15) is greater than the upper threshold, the deblurred pixel value is set to average 1006E. SAD_{E} in the above example being greater than an upper threshold may indicate that the difference and the average may vary sufficiently across a window that a region of the image 512 may be identified as a motion region. As a result of the motion, pixel values may vary more using different exposure window sizes than if the region is a stationary region. The ISP 312, in performing QCFA deblurring 500, may generate a deblurred pixel value as the determined average (such as an average determined based on equation (11) or equation (12)). In this manner, the ISP 312 may blend one or more pixel values associated a first exposure window and one or more pixel values associated with a second exposure window to reduce motion information in a pixel value of the image 512.

If the weight is between the lower threshold and the upper threshold, the deblurred pixel value may include a portion of the average and a portion of the difference. The portion of the average and the portion of the difference may be indicated by a curve from the value of the difference (at the lower threshold) to the value of the average (at the upper threshold). In some implementations, the curve between the thresholds is linear.

FIG. 11 is a depiction of an example weighting curve 1100 correlating weights 1104 to deblurred pixel values 1102. As shown, if a weight is less than a lower threshold 1106, the deblurred pixel value for the weight may be set to the difference 1110. If the weight is greater than an upper threshold 1108, the deblurred pixel value for the weight may be set to the average 1112. If the weight is between the lower threshold 1106 and the upper threshold 1108, the deblurred pixel value is a value between the difference 1110 and the average 1112 (as indicated by the curve between the lower threshold 1106 and the upper threshold 1108). In the depiction of the weighting curve 110, the curve between the lower threshold 1106 and the upper threshold 1108 is linear. However, any suitable curve may be used (such as a second order curve, another non-linear curve, a step wise function, and so on).

As used herein, the ISP 312 generating a weighting curve may refer to the ISP 312 generating an alpha used in blending the average and the difference to generate a deblurred pixel value. In this manner, the ISP 312 may not generate or plot an actual curve. For example, the ISP 312 may determine a function based on the alpha to be used in generating a deblurred pixel value. The deblurred pixel value may be determined based on alpha blending using the weight. If the weighting curve 1100 between thresholds 1106 and 1108 is linear for a QCFA deblurring process 500 performed by the ISP 312, an example alpha is depicted in equation (16) below, and an example alpha blending based on the alpha is depicted in equation (17) below:

$$\begin{matrix} alpha = \frac{weight - lower threshold}{upper threshold - lower threshold} & ( 16 ) \\ deblurred pixel value = average * alpha + difference * ( 1 - alpha ) & ( 17 )\end{matrix}$$

In one example, if the weight is halfway between the lower threshold 1106 and the upper threshold 1108, alpha equals 0.5, and the deblurred pixel value may be half the average 1112 plus half the difference 1110.

In some implementations, the ISP 312 (in performing QCFA deblurring 500) may determine the lower threshold and the upper threshold. The lower threshold and the upper threshold may be based on the distribution of the weights in the one or more weights 526 (such as the distribution of weights in the weight map). For example, the ISP 312 may determine the lower threshold to be one standard deviation below the mean weight of the weight map. The QCFA 500 may also determine the upper threshold to be one standard deviation above the mean weight of the weight map. While the lower and upper thresholds are described as one standard deviation below and above the mean weight of the weight map, any suitable thresholds may be used. For example, a threshold may be a variance from the mean weight, multiple standard deviations from the mean weight, a set distance from the mean weight, and so on. While the lower threshold and the upper threshold are described as being the same distance from a mean weight (such as one standard deviation), the lower threshold and the upper threshold may differ in distance from the mean weight. While a mean weight is described in determining the thresholds, determining the threshold may be based on a median weight or other suitable weight (such as one standard deviation below and above the median weight).

As described above, the ISP 312 (in applying the combiner 510 in FIG. 5) may determine a deblurred pixel value based on a weight. The ISP 312 may thus generate the processed image 532 by generating a deblurred pixel value (as described above) for each pixel of the processed image 532. As noted above, determining a deblurred pixel value may be based on saturation not being indicated for a weight. For example, determining a deblurred pixel value associated with a patch of the image 512 may be based on determining that the first one or more pixel values of the patch are not saturated. If the first one or more pixel values are saturated (such as a pixel value 1 being saturated), the ISP 312 (in performing QCFA deblurring 500) may not determine a deblurred pixel value for the patch as described above (such as based on the one or more weights). In some implementations, the deblurred pixel value determined for a patch of the image 512 including a saturated pixel value may instead be the same as a neighboring deblurred pixel value (for which the patch of the image 512 does not include a saturated pixel value). In some other implementations, the deblurred pixel value of the processed image 532 may be an average of one or more neighboring deblurred pixel values in the processed image 532. In some further implementations, the pixel value of the processed image 532 may be kept blank (such as not a number (NaN)) or may be set to a default value (such as a maximum value to indicate saturation).

In some implementations, the processed image 532 (FIG. 5) may then be processed by one or more ISP filters 406 (FIG. 4) of the ISP 312 (FIG. 3). For example, referring back to FIG. 4, the processed image 532 (FIG. 5) may be the CFA image. The processed image 532 may thus be input into the one or more ISP filters 406 in FIG. 4 (such as one or more of a denoising filter, an edge enhancement filter, a color balance filter, or other suitable filters) to generate the final image output by the image processing pipeline 400.

As shown, QCFA deblurring may not rely on estimating a point spread function assumed to be convolved with image data that would have been captured without blur and attempting to perform deconvolution based on the estimated point spread function to reduce blur (such as may be performed by a conventional deblurring filter of an ISP). Since deconvolution may be susceptible to errors in the point spread function and QCFA deblurring may not require estimating a point spread function, performing QCFA deblurring on the image to be processed (such as a QCFA image from the image sensor) may reduce blur in the final image better than if using only a deblurring filter of the one or more ISP filters 406 to reduce blur.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 306 in the example image processing device 300 of FIG. 3) comprising instructions that, when executed by the one or more processors 304 (or the one or more image signal processors 312), cause the device 300 to perform one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the implementations disclosed herein may be executed by one or more processors, such as the one or more processors 304 or the one or more image signal processors 312 in the example image processing device 300 of FIG. 3. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. For example, the steps of the described example operations, if performed by the image processing device 300, the one or more processors 304, and/or the one or more image signal processors 312, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method for digital image processing, comprising:
obtaining an image to be processed;
determining an average of pixel values between a first one or more pixels and a second one or more pixels of the image, wherein the second one or more pixels neighbor the first one or more pixels in the image;
determining a difference between pixel values of the first one or more pixels and the second one or more pixels;
generating one or more weights based on the average and the difference; and
combining the average and the difference based on the one or more weights to generate a deblurred pixel value, wherein a processed image includes one or more deblurred pixel values.

2. The method of claim 1, wherein:
each pixel of the first one or more pixels is associated with an exposure window of a first size; and
each pixel of the second one or more pixels is associated with an exposure window of a second size smaller than the first size.

3. The method of claim 2, further comprising:
determining a first average pixel value between a first pixel and a second pixel of the first one or more pixels;
determining a second average pixel value between a third pixel and a fourth pixel of the second one or more pixels; and
generating an adjusted second average pixel value by applying a gain to the second average pixel value, wherein the gain is based on the second size compared to the first size,
wherein:
the average includes averaging the first average pixel value and the adjusted second average pixel value; and
the difference includes subtracting the second average pixel value from the first average pixel value.

4. The method of claim 2, further comprising:
determining whether one or more pixel values of the first one or more pixels are saturated, wherein generating the deblurred pixel value is based on the pixel values of the first one or more pixels not being saturated.

5. The method of claim 2, wherein:
the image to be processed includes a plurality of patches of pixel values;
a patch of the plurality of patches includes the first one or more pixels and the second one or more pixels; and
the method further includes:
determining an average for each patch of the plurality of patches to generate a total average; and
determining a difference for each patch of the plurality of patches to generate a total difference.

6. The method of claim 5, further comprising performing one or more of:
applying a median filter to the total difference before generating the deblurred pixel value;
applying a first bilateral filter to the total average before generating the one or more weights; or
applying a second bilateral filter to the total difference before generating the one or more weights.

7. The method of claim 5, wherein generating the one or more weights includes generating a weight map including a plurality of weights, wherein for each weight of the plurality of weights:
the weight is associated with a patch of the plurality of patches; and
generating the weight includes:
adjusting a first difference of the total difference to an adjusted difference based on a first average of the total average corresponding to the first difference;
adjusting neighboring differences to the first difference of the total difference based on the adjustment to the first difference; and
determining a sum of absolute differences as the weight, wherein the sum of absolute differences includes a sum of:
an absolute difference between the first average and the adjusted first difference; and
absolute differences between each neighboring average and the corresponding adjusted neighboring difference.

8. The method of claim 7, wherein generating the one or more weights also includes generating a weighting curve, wherein generating the weighting curve includes:
determining a lower threshold based on the distribution of weights in the weight map;
determining an upper threshold based on the distribution of weights; and
determining an alpha.

9. The method of claim 8, wherein, for each corresponding average and difference of the total average and the total difference, combining the average and the difference based on the one or more weights includes:
based on a corresponding weight in the weight map being less than the lower threshold, setting the deblurred pixel value as the difference;
based on the corresponding weight being greater than the upper threshold, setting the deblurred pixel value as the average; and
based on the corresponding weight being greater than the lower threshold and less than the upper threshold, generating the deblurred pixel value as:
$$the deblurred pixel value = average * alpha - difference * ( 1 - alpha ) , wherein alpha = \frac{the corresponding weight - the lower threshold}{the upper threshold - the lower threshold} .$$

10. The method of claim 9, wherein:
the lower threshold is one standard deviation below a mean weight of the distribution of weights; and
the upper threshold is one standard deviation above the mean weight of the distribution of weights.

11. The method of claim 2, wherein:
the image to be processed is generated from an image sensor coupled to a quad color filter array; and
the first one or more pixels and the second one or more pixels are associated with color filters of a same color from the quad color filter array.

12. A device for digital image processing, comprising:
a memory; and
one or more processors configured to:
obtain an image to be processed;
determine an average of pixel values between a first one or more pixels and a second one or more pixels in the image, wherein the second one or more pixels neighbor the first one or more pixels in the image;
determine a difference between pixel values of the first one or more pixels and the second one or more pixels;
generate one or more weights based on the average and the difference; and
combine the average and the difference based on the one or more weights to generate a deblurred pixel value, wherein a processed image includes one or more deblurred pixel values.

13. The device of claim 12, wherein:
each pixel of the first one or more pixels is associated with an exposure window of a first size; and
each pixel of the second one or more pixels is associated with an exposure window of a second size smaller than the first size.

14. The device of claim 13, wherein the one or more processors are further configured to:
determine a first average pixel value between a first pixel and a second pixel of the first one or more pixels;
determine a second average pixel value between a third pixel and a fourth pixel of the second one or more pixels; and
generate an adjusted second average pixel value by applying a gain to the second average pixel value, wherein the gain is based on the second size compared to the first size,
wherein:
the average includes averaging the first average pixel value and the adjusted second average pixel value; and
the difference includes subtracting the second average pixel value from the first average pixel value.

15. The device of claim 13, wherein the one or more processors are further configured to:
determine whether one or more pixel values of the first one or more pixels are saturated, wherein generating the deblurred pixel value is based on the pixel values of the first one or more pixels not being saturated.

16. The device of claim 13, wherein:
the image to be processed includes a plurality of patches of pixel values;
a patch of the plurality of patches includes the first one or more pixels and the second one or more pixels; and
the one or more processors are further configured to:
determine an average for each patch of the plurality of patches to generate a total average; and
determine a difference for each patch of the plurality of patches to generate a total difference.

17. The device of claim 16, wherein the one or more processors are further configured to perform one or more of:
applying a median filter to the total difference before generating the deblurred pixel value;
applying a first bilateral filter to the total average before generating the one or more weights; or
applying a second bilateral filter to the total difference before generating the one or more weights.

18. The device of claim 16, wherein the one or more processors, in generating the one or more weights, are configured to generate a weight map including a plurality of weights, wherein for each weight of the plurality of weights:
the weight is associated with a patch of the plurality of patches; and
generating the weight includes:
adjusting a first difference of the total difference to an adjusted difference based on a first average of the total average corresponding to the first difference;
adjusting neighboring differences to the first difference of the total difference based on the adjustment to the first difference; and
determining a sum of absolute differences as the weight, wherein the sum of absolute differences includes a sum of:
an absolute difference between the first average and the adjusted first difference; and
absolute differences between each neighboring average and the corresponding adjusted neighboring difference.

19. The device of claim 18, wherein the one or more processors, in generating the one or more weights, are configured to generate a weighting curve, including:
determining a lower threshold based on a distribution of weights in the weight map;
determining an upper threshold based on the distribution of weights; and
determining an alpha.

20. The device of claim 19, wherein, for each corresponding average and difference of the total average and the total difference, combining the average and the difference based on the one or more weights includes:
based on a corresponding weight in the weight map being less than the lower threshold, setting the deblurred pixel value as the difference;
based on the corresponding weight being greater than the upper threshold, setting the deblurred pixel value as the average; and
based on the corresponding weight being greater than the lower threshold and less than the upper threshold, generating the deblurred pixel value as:
$$the deblurred pixel value = average * alpha - difference * ( 1 - alpha ) , wherein alpha = \frac{the corresponding weight - the lower threshold}{the upper threshold - the lower threshold} .$$

21. The device of claim 20, wherein:
the lower threshold is one standard deviation below a mean weight of the distribution of weights; and
the upper threshold is one standard deviation above the mean weight of the distribution of weights.

22. The device of claim 13, further comprising an image sensor and a quad color filter array coupled to the image sensor, wherein:
the image to be processed is generated by the image sensor; and
the first one or more pixels and the second one or more pixels are associated with color filters of a same color from the quad color filter array.

23. A non-transitory computer readable medium storing instructions that, when executed by one or more processors of a device for digital image processing, cause the device to:
obtain an image to be processed;
determine an average of pixel values between a first one or more pixels and a second one or more pixels in the image, wherein the second one or more pixels neighbor the first one or more pixels in the image;
determine a difference between pixel values of the first one or more pixels and the second one or more pixels;
generate one or more weights based on the average and the difference; and
combine the average and the difference based on the one or more weights to generate a deblurred pixel value, wherein a processed image includes one or more deblurred pixel values.

24. The computer readable medium of claim 23, wherein:
each pixel of the first one or more pixels is associated with an exposure window of a first size; and
each pixel of the second one or more pixels is associated with an exposure window of a second size smaller than the first size.

25. The computer readable medium of claim 24, wherein execution of the instructions further causes the device to:
determine a first average pixel value between a first pixel and a second pixel of the first one or more pixels;
determine a second average pixel value between a third pixel and a fourth pixel of the second one or more pixels; and
generate an adjusted second average pixel value by applying a gain to the second average pixel value, wherein the gain is based on the second size compared to the first size,
wherein:
the average includes averaging the first average pixel value and the adjusted second average pixel value; and
the difference includes subtracting the second average pixel value from the first average pixel value.

26. The computer readable medium of claim 24, wherein execution of the instructions further causes the device to:
determine whether one or more pixel values of the first one or more pixels are saturated, wherein generating the deblurred pixel value is based on the pixel values of the first one or more pixels not being saturated.

27. The computer readable medium of claim 24, wherein:
the image to be processed includes a plurality of patches of pixel values;
a patch of the plurality of patches includes the first one or more pixels and the second one or more pixels; and
execution of the instructions further causes the device to:
determine an average for each patch of the plurality of patches to generate a total average; and
determine a difference for each patch of the plurality of patches to generate a total difference.

28. The computer readable medium of claim 27, wherein execution of the instructions further causes the device to perform one or more of:
applying a median filter to the total difference before generating the deblurred pixel value;
applying a first bilateral filter to the total average before generating the one or more weights; or
applying a second bilateral filter to the total difference before generating the one or more weights.

29. The computer readable medium of claim 27, wherein generating the one or more weights includes generating a weight map including a plurality of weights, wherein for each weight of the plurality of weights:
the weight is associated with a patch of the plurality of patches; and
generating the weight includes:
adjusting a first difference of the total difference to an adjusted difference based on a first average of the total average corresponding to the first difference;
adjusting neighboring differences to the first difference of the total difference based on the adjustment to the first difference; and
determining a sum of absolute differences as the weight, wherein the sum of absolute differences includes a sum of:
an absolute difference between the first average and the adjusted first difference; and
absolute differences between each neighboring average and the corresponding adjusted neighboring difference.

30. The computer readable medium of claim 29, wherein:
generating the one or more weights includes generating a weighting curve, including:
determining a lower threshold based on a distribution of weights in the weight map;
determining an upper threshold based on the distribution of weights; and
determining an alpha; and
for each corresponding average and difference of the total average and the total difference, combining the average and the difference based on the one or more weights includes:
based on a corresponding weight in the weight map being less than the lower threshold, setting the deblurred pixel value as the difference;
based on the corresponding weight being greater than the upper threshold, setting the deblurred pixel value as the average; and
based on the corresponding weight being greater than the lower threshold and less than the upper threshold, generating the deblurred pixel value as:
$$the deblurred pixel value = average * alpha - difference * ( 1 - alpha ) , wherein alpha = \frac{the corresponding weight - the lower threshold}{the upper threshold - the lower threshold} .$$
